(19) United States
(12) Patent Application Publication
(10) Pub. No.: US 2025/0253332 A1
(43) Pub. Date: Aug. 7, 2025

(54) Rechargeable Battery

(71) Applicant: Nanyang Technological University, Singapore (SG)

(72) Inventors: Seok Woo LEE, Singapore (SG); Jeonghun YUN, Singapore (SG); Zongkang LI, Singapore (SG)

(21) Appl. No.: 19/048,177

(22) Filed: Feb. 7, 2025

(30) Foreign Application Priority Data
Feb. 7, 2024 (SG) 10202400349U

(51) Int. Cl. H01M 4/60; G02C 11/00; H01M 10/26; H01M 10/46; H01M 50/247

(52) U.S. Cl. CPC H01M 4/608; G02C 11/10; H01M 10/26; H01M 10/46; H01M 50/247; H01M 2220/30

(57) ABSTRACT

The present invention provides a rechargeable battery comprising a cathode comprising metal hexacyanometalate or hydrates thereof, or metal-doped metal hexacyanometalate or hydrates thereof, and glucose oxidase (GOx); and an anode comprising a self-reducing polymer. The present invention further provides a smart contact lens integrated with said rechargeable battery.

### CROSS-REFERENCE TO RELATED APPLICATION

This application claims priority to Singapore Application No. 10202400349U, filed on Feb. 7, 2024, which is hereby incorporated by reference in its entirety.

### TECHNICAL FIELD

The present disclosure generally relates to a rechargeable battery, more particularly, a rechargeable battery capable of self-charging. The rechargeable battery may be embedded in contact lenses for smart contact lens applications.

### BACKGROUND ART

Smart contact lenses are wearable devices that promise to provide wearers with both medical diagnostics and personal applications and are typically composed of sensors, wireless communicators, actuators, and power supplies. Such smart contact lenses, especially developed for medical and personal applications require miniaturized power supplies, integrated batteries are thus crucial in such applications to ensure that they can continue functioning through daily usage. However, integrating batteries into small wearable devices is challenging because it is difficult to transfer electrical power to the batteries, be it via a miniaturized wired connection or via wireless transmission. Accordingly, the development of the appropriate power supplies for smart contact lenses has focused on providing power via inductive power transmission, supercapacitors, biofuel cells, or batteries.

However, all these approaches have unresolved technical challenges that obstruct their commercialization with smart lenses. Although inductive power transmission can supply high power without safety issues caused by the generated heat, the user will be encumbered by need to have both the transmitter and receiver within a certain distance. This limitation would not impede some applications, such as medical diagnostics, but is unsuitable for incorporation into lenses for everyday use. Biofuel cells can generate their own power in vivo but are typically unable to provide sufficient power densities for most applications.

Conventional batteries may overcome both issues, providing sufficient power to the smart lens without encumbering the wearer with power transmission equipment. However, conventional batteries contain various hazardous materials, such as organic solvents, concentrated salts, or heavy metals, that could cause severe eye damage if leaked.

Therefore, the development of safe rechargeable batteries is necessary for smart contact lens applications, and there is a need to find new batteries that overcome or ameliorates one or more of the abovementioned problems.

### SUMMARY

Herein, a rechargeable battery that can be integrated into contact lenses, and can be charged by biofuel is provided. The presently disclosed rechargeable battery can be easily charged without an external electrical source, by simply placing the battery in a biofuel solution.

Accordingly, an aspect of the present disclosure provides a rechargeable battery comprising:
(i) a cathode, the cathode comprising:
   metal hexacyanometalate, or hydrates thereof, or metal-doped metal hexacyanometalate or hydrates thereof, and
   glucose oxidase (GOx); and
(ii) an anode comprising a self-reducing polymer.

Another aspect of the present disclosure provides a contact lens comprising the rechargeable battery disclosed herein.

The presently disclosed rechargeable battery may not contain organic solvents, concentrated salts or heavy metals commonly found in conventional batteries, and thus advantageously do not pose a health risk to the user when used, or in the event of leakage or damage to the battery. The presently disclosed battery may also use human tears as an electrolyte during the discharging process and does not require any discharging electrolyte containing any organic solvents, concentrated salts, or heavy metals, and thus advantageously do not pose a health risk to the user.

The presently disclosed rechargeable battery also may not require conventional transmitter/receiver components common required in inductive power transmissions, thus further simplifying and improving the ease of miniaturization of the battery into the smart contact lens.

The rechargeable battery may be self-charged in biofuel solutions, which includes glucose, glucose solutions, human tears and/or animal tears. This advantageously allows the battery to be charged even while being worn by a user.

The use of enzymes to charge the rechargeable battery eliminates the need for membranes in the cell, thus further simplifying the battery setup and enhancing the ease of miniaturization of the battery for small wearable device applications, e.g., in smart contact lens, tooth monitoring devices, or smart patches. The battery may have one electrode that is self-charging without requiring additional oxidant or reductant results in a charging solution that only needs to contain the necessary oxidant or reductant for charging the second electrode, advantageously simplifying the composition of the charging solution. Because the presently disclosed battery may not require any harsh oxidizing and/or reducing agents to charge the electrodes, the battery advantageously avoids the issue of needing to selectively induce redox reactions on either the cathode and/or anode.

The presently disclosed battery may have thin electrodes, and can thus be integrated into conventional contact lenses without increasing their thickness. This advantageously simplifies the production of such lenses and advantageously enhances wearing experience for the user.

### Definitions

Unless otherwise defined herein, scientific and technical terms used in this application shall have the meanings that are commonly understood by those of ordinary skill in the art. Generally, nomenclature used in connection with, and techniques of, chemistry described herein, are those well-known and commonly used in the art.

Unless the context requires otherwise or specifically stated to the contrary, integers, steps, or elements of the invention recited herein as singular integers, steps or elements clearly encompass both singular and plural forms of the recited integers, steps or elements.

As used herein in relation to metal hexacyanometalates or metal-doped metal hexacyanometalates, “hydrates” refer to a coordination compound comprising a metal hexacyanometalate or metal-doped metal hexacyanometalate framework with water molecules incorporated within its structure. These water molecules may be present as (i) coordinated water directly bonded to metal centers, (ii) interstitial water occupying voids within the crystalline lattice, or (iii) hydration water associated with the overall stability of the material.

As used herein, “metal-doped metal hexacyanometalates” refer to metal hexacyanometalate compounds in which one or more additional metal ions are incorporated into the structure. The doping metal may partially replace either (i) the transition metal coordinated to the cyanide ligands or (ii) the metal center within the hexacyanometalate anion.

As used herein, the term “self-charging” refers to the ability of the battery to be charged without needing an external electrical source.

As used herein, the term “self-reduction”, “self-reducing”, or “self-reduceable” refers to the ability of the battery, in particular the electrode or active material, to be reduced under ambient conditions, e.g., r.t.p. conditions, physiological conditions, without requiring any reducing agents (reductants).

As used herein, the term “self-reducing polymer” refers to a polymer that can be reduced under ambient conditions, e.g., r.t.p. conditions, physiological conditions, without requiring any reducing agents (reductants).

As used herein, the term “biofuel” refers to biological compounds, intermediates, metabolites that are present in humans or animals and may be reacted upon by enzymes to provide further intermediates to oxidize and/or reduce active materials on electrodes. Typically, such biofuels are glucose, lactic acid, etc.

The word “substantially” does not exclude “completely” e.g. a composition which is “substantially free” from Y may be completely free from Y. Where necessary, the word “substantially” may be omitted from the definition of the invention.

As used herein in the specification and in the claims, the phrase “at least,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### BRIEF DESCRIPTION OF DRAWINGS

The accompanying drawings illustrate disclosed embodiments and serve to explain the principles of the disclosed embodiments. It is to be understood, however, that the drawings are designed for purposes of illustration only, and not as a definition of the limits of the invention.

FIG. 1 shows (a) an illustration of a smart contact lens having a rechargeable battery in an embodiment of the present invention being charged in a contact lens case; and (b) the charging mechanism of the battery.

FIG. 2 shows a schematic for fabricating an electrode of a rechargeable battery of the present invention.

FIG. 3 are images showing (a) the rechargeable battery of the present invention embedded into a contact lens; (b) the contact lens having said battery reversibly bending under pressure; and (c) a graph showing the transmittance of the contact lens disclosed herein as compared to a normal contact lens (inset: the presently disclosed lens placed over an image).

FIG. 4 are images showing microscopic images of the lens cleaning paper used at (a) lower and (b) higher magnification.

FIG. 5 show (a) top-side and (b) bottom-side images of the lens cleaning paper of FIG. 4 coated with the CuHCFe electrode, prior to coating of the GOx layer.

FIG. 6 show (a) an image of a PPy electrode of a rechargeable battery of the present invention; and (d) the same PPy electrode undergoing resistance measurement with the 4-probe method of Example 3.

FIG. 7 show (a) a cross-sectional scanning microscope image of a CuHCFe electrode of a rechargeable battery of the present invention; and (b) a cross-sectional optical microscope image of the rechargeable battery of the present invention embedded in a contact lens.

FIG. 8 shows (a) a SEM image, (b) an XRD spectrum, and (c) a Raman spectrum of a CuHCFe active material, and (d) a SEM image, (e) an XRD spectrum, and (f) a Raman spectrum of a PPy active material.

FIG. 9 shows images of a rechargeable battery of the present invention (a) bent with the mechanical tester with a 100 Hz external force and (b) released; (c) a corresponding graph showing the discharging capacity of the battery with and without the 100 Hz external force; images of the battery (d) bent with fingers and (e) released; and (f) a graph showing the OCV of the battery during the bending process.

FIG. 10 shows (a) graph of the charging curve of a CuHCFe/GOx cathode of a rechargeable battery of the present invention in a glucose solution; (b) a graph of the discharging curve of the CuHCFe/GOx cathode in an artificial tear solution; (c) a graph showing the dependency of glucose concentration on the charging of a CuHCFe electrode of a rechargeable battery of the present invention; (d) a graph of the charging curve of a PPy anode of a rechargeable battery of the present invention; (e) a graph of the discharging curve of the PPy electrode, and (f) a graph showing the cyclic performance when the CuHCe and PPy electrodes are charged in a 100 mM glucose solution.

FIG. 11 is a graph showing the Cyclic Voltammetry (CV) curves of a CuHCFe electrode of a rechargeable battery of the present invention at various KCl concentrations.

FIG. 12 is a graph showing the discharging curves of a CuHCFe electrode of a rechargeable battery of the present invention (black line) when bio-charged and (dashed line) when electrochemically charged.

FIG. 13 is a graph showing the discharging curves of a CuHCFe electrode of a rechargeable battery of the present invention after being charged in (black line) a distilled water (DI-water) based glucose solution and (dashed line) a tear-based glucose solution.

FIG. 14 is a graph showing the discharging curves of a CuHCFe electrode of a rechargeable battery of the present invention after being charged in (black line) a DI-water based glucose solution and (dashed line) DI water.

FIG. 15 is a graph showing the discharging curves of a PPy electrode of a rechargeable battery of the present invention in different charging solutions: 100 mM glucose, 10 mM glucose, artificial tear solution, and DI water.

FIG. 16 are a set of graphs showing (a) the charging and discharging cycle of a rechargeable battery of the present invention; and (b) the cyclic performance of the battery.

FIG. 17 is a graph showing the discharging curves of a battery of the present invention charged after being stored in a refrigerator for 12 days.

FIG. 18 is a graph showing the discharging curves of a battery of the present invention after being charged for 20 hours and 45 hours.

FIG. 19 show microscope images of live and dead cells when the cells were introduced to a reference hydrogel lens and a contact lens with a rechargeable battery of the present invention being charged and discharged over 24 hours, with the scale bar being 100 μm.

FIG. 20 is a graph showing the discharging curves of a rechargeable battery of the present invention after undergoing charging or electrical charging,

FIG. 21 are a set of graph showing (a) electrical charging and discharging curves of a rechargeable battery of the present invention with cutoff voltages of 1 V and 0 V, and (b) the cyclic performance of the battery.

FIG. 22 is a graph showing the self-discharging of a rechargeable battery of the present invention, indicated by the OCV of the battery after being charged under a 100 μA current for 1 hour, 5 hours, and 10 hours respectively and discharging.

FIG. 23 is a set of graphs showing (a) the discharging curves of a battery at various discharging current, and (b) the corresponding maximum power output compared to conventional biofuel cells.

### DETAILED DISCLOSURE OF DRAWINGS

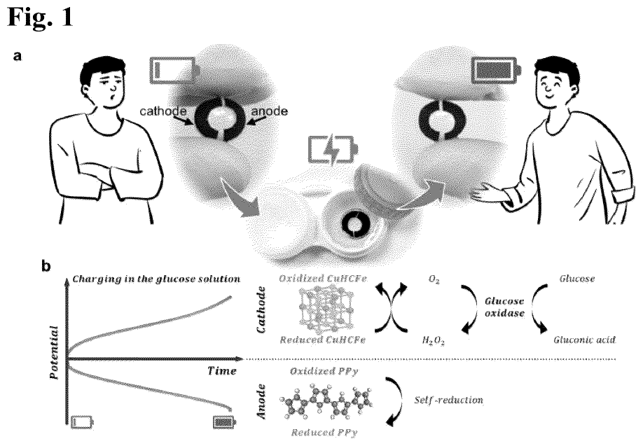

FIG. 1a shows a smart contact lens integrated with a rechargeable battery of the present invention being charged by simply leaving the contact lens in a contact lens case with a charging solution comprising glucose overnight. FIG. 1b is a graphical illustration of the charging reactions that take place during the self charging: the GOx oxidises glucose to H₂O₂, which then oxidises the hexacyanoferrate(II) on the cathode to hexacyanoferrate(III). At the anode, the PPy is automatically reduced in the presence of hydroxide ions to the reduced form.

Active material is mixed with various components (i) and coated over the substrate and left to dry (ii). A GOx enzyme solution is then coated over the substrate (iii) following which, a GTA solution was applied (iv) to immobilize the enzymes. After drying, the coated electrodes are cut into the desired shapes for further integration (v).

### DETAILED DISCLOSURE OF EMBODIMENTS

The present invention provides a rechargeable battery that can be powered by a self-charging cathode and/or self-charging anode and thus does not require external electrical power sources to charge the battery. The cathode may be self-charged via products from enzymatic reactions in a charging solution, and the anode may be self-charged via self reduction.

The present invention provides a rechargeable battery comprising:
(i) a cathode, the cathode comprising:
   metal hexacyanometalate or hydrates thereof, or metal-doped metal hexacyanometalate or hydrates thereof, and
   glucose oxidase; and
(ii) an anode comprising a self-reducing polymer.

In some embodiments, both the cathode and anode undergo self-charging. The cathode and anode of said rechargeable battery are each capable of undergoing self-charging, thus allowing for the rechargeable battery to be charged without requiring an external electrical source.

The reduction potential of the self-reducing polymer may either be negative or positive and will depend on the potential of the cathode half cell in the rechargeable battery. To maximise the output voltage of the rechargeable battery, a negative reduction potential may be preferred.

For example, the reduction potential of the anode may be in a range of at least about −0.5 V, at least about −0.25 V; or about −0.5 V to about 0.5 V, about −0.5 V to about 0.4 V, about −0.5 V to about 0.3 V, about −0.5 V to about 0.25 V, about −0.5 V to about 0.2 V, about −0.5 V to about 0.1 V, about −0.5 V to about 0 V, about −0.5 V to about −0.1 V, about −0.5 V to about −0.2 V, about −0.5 V to about −0.25 V, about −0.5 V to about −0.3 V, about −0.5 V to about −0.4 V, about 0.25 V to about 0.5 V, about 0.25 V to about 0.4 V, about 0.25 V to about 0.3 V; or about −0.5 V to about 0.5 V, about −0.4 V to about 0.5 V, about −0.3 V to about 0.5 V, about −0.25 V to about 0.5 V, about −0.2 V to about 0.5 V, about −0.1 V to about 0.5 V, about 0 V to about 0.5 V, about 0.1 V to about 0.5 V, about 0.2 V to about 0.5 V, about 0.25 V to about 0.5 V, about 0.3 V to about 0.5 V, about 0.4 V to about 0.5 V, about −0.5 V to about 0.25 V, about −0.4 V to about 0.25 V, about −0.3 V to about 0.25 V, about −0.25 V to about 0.25 V, about −0.2 V to about 0.25 V, about −0.1 V to about 0.25 V, about 0 V to about 0.25 V, about 0.1 V to about 0.25 V, about 0.2 V to about 0.25 V; or at most about −0.25 V, at most about 0.5 V; or about −0.5 V, about −0.4 V, about −0.3 V, about −0.25 V, about −0.2 V, about −0.1 V, about 0 V, about 0.1 V, about 0.2 V, about 0.25 V, about 0.3 V, about 0.4 V, about 0.5 V, or any ranges or values therebetween.

The cathode and anode of the present invention may undergo self-charging in biofuel. In some embodiments, this biofuel may be in the form of a glucose charging electrolyte. In some other embodiments, the biofuel may be in the form of human tears. This accordingly allows the battery of the present invention to be chargeable in more than one way, e.g, by immersing in a charging electrolyte, or in tears while being worn. Advantageously, this not just improves the charging capacity of the battery, but also increasing the operating duration of the battery as it can continue self-charging based on biofuel, e.g., glucose found in tears while being worn by the user.

In some embodiments, said biofuel source may be glucose, lactate, lactic acid, or any other sugars or carbohydrate sources that may be broken down by the enzymes into intermediates to charge the electrode. Said intermediate may be H₂O₂, or any other intermediate capable of oxidizing/reducing the cathode/anode to charge the battery.

In some embodiments, the cathode undergoes self-charging in biofuel, e.g., glucose, but the anode undergoes self-charging without requiring any additional reductants. Accordingly, both the cathode and anode may be charged in the same electrolyte having a single biofuel. This simplifies the charging electrolyte design and reduces cross-reaction and/or other undesirable redox reactions happening at either the cathode or the anode. In some embodiments, both the cathode and anode undergo self-charging in an electrolyte comprising glucose.

The battery of the invention may be charged in human tears (which naturally comprise glucose), or be charged in a contact lens solution comprising glucose. In another embodiment, the charging electrolyte does not contain any salts.

The cathode may self-charge via oxidation of glucose by glucose oxidase to produce H₂O₂ which oxidizes the metal hexacyanometalate or hydrates thereof, or metal-doped metal hexacyanometalate or hydrates thereof. The anode may self-charge via self-reduction of the self-reducing polymer in the presence of hydroxide ions.

The electrolyte may be selected from the group consisting of biofuel, glucose, a biofuel solution, a glucose solution, human tears, animal tears, and a contact lens solution.

In some embodiments, the metal of the metal hexacyanometalate, or hydrates thereof, may be copper, manganese, iron, cobalt, nickel, and/or zinc.

In some embodiments, the hexacyanometalate of the metal hexacyanometalate, or hydrates thereof, or the hexacyanometalate of the metal-doped metal hexacyanometalate, or hydrates thereof, may be hexacyanoferrate, hexacyanidocobaltate, hexacyanochromate, hexacyanomanganate, and/or copper hexacyanoruthenate.

In some embodiments, the metal hexacyanometalate of the metal-doped metal hexacyanometalate, or hydrates thereof, may be copper hexacyanometalate, manganese hexacyanometalate, iron hexacyanometalate, cobalt hexacyanometalate, nickel hexacyanometalate, and/or zinc hexacyanometalate.

In some embodiments, the metal-doped metal hexacyanometalate, or hydrates thereof, may be lithium-doped, sodium-doped, potassium-doped, rubidium-doped, caesium-doped, magnesium-doped, calcium-doped, zinc-doped, and/or aluminium-doped metal hexacyanometalate, or hydrates thereof.

The metal hexacyanometalate, or hydrates thereof, may be copper hexacyanoferrate, or hydrates thereof, copper hexacyanidocobaltate, or hydrates thereof, copper hexacyanochromate, or hydrates thereof, copper hexacyanomanganate, or hydrates thereof, or copper hexacyanoruthenate, or hydrates thereof.

The metal hexacyanometalate of the metal-doped metal hexacyanometalate, or hydrates thereof, may be copper hexacyanoferrate, copper hexacyanidocobaltate, copper hexacyanochromate, copper hexacyanomanganate, or hydrates thereof, or copper hexacyanoruthenate.

The metal-doped metal hexacyanometalate, or hydrates thereof, may be lithium-doped, sodium-doped, potassium-doped, rubidium-doped, caesium-doped, magnesium-doped, calcium-doped, zinc-doped, or aluminium-doped metal hexacyanometalate, or hydrates thereof.

The metal-doped metal hexacyanometalate, or hydrates thereof, may be lithium-doped, sodium-doped, potassium-doped, rubidium-doped, caesium-doped, magnesium-doped, calcium-doped, zinc-doped, or aluminium-doped copper hexacyanidocobaltate, or hydrates thereof, copper hexacyanochromate, or hydrates thereof, copper hexacyanomanganate, or hydrates thereof, or copper hexacyanoruthenate, or hydrates thereof.

The metal hexacyanometalate, or hydrates thereof, may be manganese hexacyanoferrate, or hydrates thereof, manganese hexacyanidocobaltate, or hydrates thereof, manganese hexacyanochromate, or hydrates thereof, manganese hexacyanomanganate, or hydrates thereof, or manganese hexacyanoruthenate, or hydrates thereof.

The metal hexacyanometalate, or hydrates thereof, may be iron hexacyanoferrate, or hydrates thereof, iron hexacyanidocobaltate, or hydrates thereof, iron hexacyanochromate, or hydrates thereof, iron hexacyanomanganate, or hydrates thereof, or iron hexacyanoruthenate, or hydrates thereof.

The metal hexacyanometalate, or hydrates thereof, may be cobalt hexacyanoferrate, or hydrates thereof, cobalt hexacyanidocobaltate, or hydrates thereof, cobalt hexacyanochromate, or hydrates thereof, cobalt hexacyanomanganate, or hydrates thereof, or cobalt hexacyanoruthenate, or hydrates thereof.

The metal hexacyanometalate, or hydrates thereof, may be nickel hexacyanoferrate, or hydrates thereof, nickel hexacyanidocobaltate, or hydrates thereof, nickel hexacyanochromate, or hydrates thereof, nickel hexacyanomanganate, or hydrates thereof, or nickel hexacyanoruthenate, or hydrates thereof.

The metal hexacyanometalate, or hydrates thereof, may be zinc hexacyanoferrate, or hydrates thereof, zinc hexacyanidocobaltate, or hydrates thereof, zinc hexacyanochromate, or hydrates thereof, zinc hexacyanomanganate, or hydrates thereof, or zinc hexacyanoruthenate, or hydrates thereof.

The metal hexacyanometalate of the metal-doped metal hexacyanometalate, or hydrates thereof, may be manganese hexacyanoferrate, manganese hexacyanidocobaltate, manganese hexacyanochromate, manganese hexacyanomanganate, or hydrates thereof, or manganese hexacyanoruthenate.

The metal hexacyanometalate of the metal-doped metal hexacyanometalate, or hydrates thereof, may be iron hexacyanoferrate, iron hexacyanidocobaltate, iron hexacyanochromate, iron hexacyanomanganate, or hydrates thereof, or iron hexacyanoruthenate.

The metal hexacyanometalate of the metal-doped metal hexacyanometalate, or hydrates thereof, may be cobalt hexacyanoferrate, cobalt hexacyanidocobaltate, cobalt hexacyanochromate, cobalt hexacyanomanganate, or hydrates thereof, or cobalt hexacyanoruthenate.

The metal hexacyanometalate of the metal-doped metal hexacyanometalate, or hydrates thereof, may be nickel hexacyanoferrate, nickel hexacyanidocobaltate, nickel hexacyanochromate, nickel hexacyanomanganate, or hydrates thereof, or nickel hexacyanoruthenate.

The metal hexacyanometalate of the metal-doped metal hexacyanometalate, or hydrates thereof, may be zinc hexacyanoferrate, zinc hexacyanidocobaltate, zinc hexacyanochromate, zinc hexacyanomanganate, or hydrates thereof, or zinc hexacyanoruthenate.

The metal-doped metal hexacyanometalate, or hydrates thereof, may be lithium-doped, sodium-doped, potassium-doped, rubidium-doped, caesium-doped, magnesium-doped, calcium-doped, zinc-doped, or aluminium-doped metal hexacyanometalate, or hydrates thereof.

The metal-doped metal hexacyanometalate, or hydrates thereof, may be lithium-doped, sodium-doped, potassium-doped, rubidium-doped, caesium-doped, copper-doped, calcium-doped, zinc-doped, or aluminium-doped manganese hexacyanidocobaltate, or hydrates thereof, manganese hexacyanochromate, or hydrates thereof, manganese hexacyanomanganate, or hydrates thereof, or manganese hexacyanoruthenate, or hydrates thereof.

The metal-doped metal hexacyanometalate, or hydrates thereof, may be lithium-doped, sodium-doped, potassium-doped, rubidium-doped, caesium-doped, magnesium-doped, calcium-doped, zinc-doped, copper-doped or aluminium-doped iron hexacyanidocobaltate, or hydrates thereof, iron hexacyanochromate, or hydrates thereof, iron hexacyanomanganate, or hydrates thereof, or iron hexacyanoruthenate, or hydrates thereof.

The metal-doped metal hexacyanometalate, or hydrates thereof, may be lithium-doped, sodium-doped, potassium-doped, rubidium-doped, caesium-doped, magnesium-doped, calcium-doped, zinc-doped, copper-doped or aluminium-doped cobalt hexacyanidocobaltate, or hydrates thereof, cobalt hexacyanochromate, or hydrates thereof, cobalt hexacyanomanganate, or hydrates thereof, or cobalt hexacyanoruthenate, or hydrates thereof.

The metal-doped metal hexacyanometalate, or hydrates thereof, may be lithium-doped, sodium-doped, potassium-doped, rubidium-doped, caesium-doped, magnesium-doped, calcium-doped, zinc-doped, copper-doped or aluminium-doped nickel hexacyanidocobaltate, or hydrates thereof, nickel hexacyanochromate, or hydrates thereof, nickel hexacyanomanganate, or hydrates thereof, or nickel hexacyanoruthenate, or hydrates thereof.

The metal-doped metal hexacyanometalate, or hydrates thereof, may be lithium-doped, sodium-doped, potassium-doped, rubidium-doped, caesium-doped, magnesium-doped, calcium-doped, zinc-doped, or aluminium-doped zinc hexacyanidocobaltate, or hydrates thereof, zinc hexacyanochromate, or hydrates thereof, zinc hexacyanomanganate, or hydrates thereof, or zinc hexacyanoruthenate, or hydrates thereof.

The metal hexacyanometalate, or hydrates thereof, or metal-doped metal hexacyanometalate, or hydrates thereof may be of Formula (1):

A_{y}M_{Ax}[M_{B}(CN)₆]_{z}·nH₂O —Formula (1)
where:
   A is a metal;
   M_{A} is a metal;
   M_{B} is a transition metal;
   n is 0≤n≤18;
   x is 0<x≤4;
   y is 0≤y≤4; and
   z is 0<z>4.

A, M_{A} and M_{B} may be univalent, divalent, trivalent, tetravalent and/or multivalent metals.

In some embodiments, A may be a metal. The metal may be an alkali metal, e.g, Li, K, Na, Rb, or Cs, or an alkali earth metal, e.g., Mg, Ca, Sr, or Ba, or a transition metal, e.g., Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, or Hg, or any other metal, e.g., Al. In some embodiments, A may be Li, K, Na, Rb, Cs, Mg, Ca, Al, Mn, Fe, Co, Ni, Zn, or Cu.

In some embodiments, M_{A} may be a metal. The metal may be an alkali metal, e.g, Li, K, Na, Rb, or Cs, or an alkali earth metal, e.g., Mg, Ca, Sr, or Ba, or a transition metal, e.g., Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, or Hg. In some embodiments, M_{A} may be a transition metal, e.g., Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, or Hg. In some embodiments, M_{A} may be Mn, Fe, Co, Ni, Zn, or Cu.

In some embodiments, M_{B} may be a transition metal, e.g., Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, or Hg. In other embodiments, M_{B} may be Fe, Co, Cr, Mn, or Ru. In some other embodiments, the hexacyanometalate (M_{B}(CN)₆) may be hexacyanoferrate, hexacyanocobaltate, hexacyanochromate, hexacyanomanganate, or hexacyanoruthenate.

n, x, y and z may vary depending on the preparation conditions and the amount of starting materials used in the preparation of the metal hexacyanometalate. Various exemplary ranges and values are provided below, but it will be understood by the skilled person that the present disclosure is not limited to the disclosed values and ranges.

n may be about 0≤n≤ about 18, about 1≤n≤ about 18, about 2≤n≤ about 18, about 3≤n≤ about 18, about 3.7≤n≤ about 18, about 4≤n≤ about 18, about 5≤n≤ about 18, about 65≤n≤ about 18, about 7≤n≤ about 18, about 8≤n≤ about 18, about 9≤n≤ about 18, about 10≤n≤ about 18, about 11≤n≤ about 18, about 12≤n≤ about 18, about 13≤n≤ about 18, about 14≤n≤ about 18, about 15≤n≤ about 18, about 16≤n≤ about 18, about 17≤n≤ about 18; about 0≤n≤ about 3.7, about 1≤n≤ about 3.7, about 2≤n≤ about 3.7, about 3≤n≤ about 3.7; about 0≤n≤ about 1, about 0≤n≤ about 2, about 0≤n≤ about 3, about 0≤n≤ about 3.7, about 0≤n≤ about 4, about 0≤n≤ about 5, about 0≤n≤ about 6, about 0≤n≤ about 7, about 0≤n≤ about 8, about 0≤n≤ about 9, about 0≤n≤ about 10, about 0≤n≤ about 11, about 0≤n≤ about 12, about 0≤n≤ about 13, about 0≤n≤ about 14, about 0≤n≤ about 15, about 0≤n≤ about 16, about 0≤n≤ about 17; about 0.37≤n≤ about 4, about 0.37≤n≤ about 5, about 0.37≤n≤ about 6, about 0.37≤n≤ about 7, about 0.37≤n≤ about 8, about 0.37 n≤ about 9, about 0.37≤n≤ about 10, about 0.37≤n≤ about 11, about 0.37≤n≤ about 12, about 0.37≤n≤ about 13, about 0.37≤n≤ about 14, about 0.37≤n≤ about 15, about 0.37≤n≤ about 16, about 0.37≤n≤ about 17; at least about 0; at most about 18; about 0, about 1, about 2, about 3, about 3.7, about 4, about 5, about 6, about 7, about 8, about 9, about 10, about 11, about 12, about 13, about 14, about 15, about 16, about 17, about 18 or any ranges or values therebetween.

x may be about 0≤x≤ about 4, about 0.1≤x≤ about 4, about 0.2≤x≤ about 4, about 0.25≤x≤ about 4, about 0.33≤x≤ about 4, about 0.5≤x≤ about 4, about 0.67≤x≤ about 4, about 0.71≤x≤ about 4, about 0.72≤x≤ about 4, about 0.75≤x≤ about 4, about 0.8≤x≤ about 4, about 1≤x≤ about 4, about 1.5≤x≤ about 4, about 1.71≤x≤ about 4, about 1.72≤x≤ about 4, about 2≤x≤ about 4, about 2.5≤x≤ about 4, about 3≤x≤ about 4, about 3.5≤x≤ about 4; about 0≤x≤ about 1, about 0.1≤x≤ about 1, about 0.2≤x≤ about 1, about 0.25≤x≤ about 1, about 0.33≤x≤ about 1, about 0.5≤x≤ about 1, about 0.67≤x≤ about 1, about 0.71≤x≤ about 1, about 0.72≤x≤ about 1, about 0.75≤x≤ about 1, about 0.8≤x≤ about 1; about 0≤x≤ about 0.71, about 0.1≤x≤ about 0.71, about 0.2≤x≤ about 0.71, about 0.25≤x≤ about 0.71, about 0.33≤x≤ about 0.71, about 0.5≤x≤ about 0.71, about 0.67≤x≤ about 0.71; about 0≤x≤ about 0.1, about 0≤x≤ about 0.2, about 0≤x≤ about 0.25, about 0≤x≤ about 0.33, about 0≤x≤ about 0.5, about 0≤x≤ about 0.67, about 0≤x≤ about 0.71, about 0≤x≤ about 0.72, about 0≤x≤ about 0.75, about 0≤x≤ about 0.8, about 0≤x≤ about 1, about 0≤x≤ about 1.5, about 0≤x≤ about 1.71, about 0≤x≤ about 1.72, about 0≤x≤ about 2, about 0≤x≤ about 2.5, about 0≤x≤ about 3, about 0≤x≤ about 3.5; about 0.71≤x≤ about 0.72, about 0.71≤x≤ about 0.75, about 0.71≤x≤ about 0.8, about 0.71≤x≤ about 1, about 0.71≤x≤ about 1.5, about 0.71≤x≤ about 1.71, about 0.71≤x≤ about 1.72, about 0.71≤x≤ about 2, about 0.71≤x≤ about 2.5, about 0.71≤x≤ about 3, about 0.71≤x≤ about 3.5, about 0.71≤x≤ about 4; about 1≤x≤ about 1.5, about 1≤x≤ about 1.71, about 1≤x≤ about 1.72, about 1≤x≤ about 2, about 1≤x≤ about 2.5, about 1≤x≤ about 3, about 1≤x≤ about 3.5, about 1≤x≤ about 4; at least about 0, at least about 0.71, at least about 0.72, at least about 1.71, at least about 1.72; at most about 0.71, at most about 0.72, at most about 1.71, at most about 1.72, at most about 4; about 0, about 0.1, about 0.2, about 0.25, about 0.33, about 0.5, about 0.67, about 0.71, about 0.72, about 0.75, about 0.8, about 1, about 1.5, about 1.71, about 1.72, about 2, about 2.5, about 3, about 3.5, about 4, or any ranges or values therebetween.

y may be about 0≤y≤ about 4, about 0.1≤y≤ about 4, about 0.2≤y≤ about 4, about 0.25≤y≤ about 4, about 0.33≤y≤ about 4, about 0.5≤y≤ about 4, about 0.67≤y≤ about 4, about 0.71≤y≤ about 4, about 0.72≤y≤ about 4, about 0.75≤y≤ about 4, about 0.8≤y≤ about 4, about 1≤y≤ about 4, about 1.5≤y≤ about 4, about 1.71≤y≤ about 4, about 1.72≤y≤ about 4, about 2≤y≤ about 4, about 2.5≤y≤ about 4, about 3≤y≤ about 4, about 3.5≤y≤ about 4; about 0≤y≤ about 1, about 0.1≤y≤ about 1, about 0.2≤ y≤ about 1, about 0.25≤y≤ about 1, about 0.33≤y≤ about 1, about 0.5≤y≤ about 1, about 0.67≤y≤ about 1, about 0.71≤y≤ about 1, about 0.72≤y≤ about 1, about 0.75≤y≤ about 1, about 0.8≤y≤ about 1; about 0≤y≤ about 0.71, about 0.1≤y≤ about 0.71, about 0.2≤y≤ about 0.71, about 0.25≤y≤ about 0.71, about 0.33≤y≤ about 0.71, about 0.5≤y≤ about 0.71, about 0.67≤y≤ about 0.71; about 0≤y≤ about 0.1, about 0≤y≤ about 0.2, about 0≤y≤ about 0.25, about 0≤y≤ about 0.33, about 0≤y≤ about 0.5, about 0≤y≤ about 0.67, about 0≤y≤ about 0.71, about 0≤y≤ about 0.72, about 0≤y≤ about 0.75, about 0≤y≤ about 0.8, about 0≤y≤ about 1, about 0≤y≤ about 1.5, about 0≤y≤ about 1.71, about 0≤y≤ about 1.72, about 0≤y≤ about 2, about 0≤y≤ about 2.5, about 0≤y≤ about 3, about 0≤y≤ about 3.5; about 0.71≤y≤ about 0.72, about 0.71≤y≤ about 0.75, about 0.71≤y≤ about 0.8, about 0.71≤y≤ about 1, about 0.71≤y≤ about 1.5, about 0.71≤y≤ about 1.71, about 0.71≤y≤ about 1.72, about 0.71≤y≤ about 2, about 0.71≤y≤ about 2.5, about 0.71≤y≤ about 3, about 0.71≤y≤ about 3.5, about 0.71≤y≤ about 4; about 1≤y≤ about 1.5, about 1≤y≤ about 1.71, about 1≤y≤ about 1.72, about 1≤y≤ about 2, about 1≤y≤ about 2.5, about 1≤y≤ about 3, about 1≤y≤ about 3.5, about 1≤y≤ about 4; at least about 0, at least about 0.71, at least about 0.72, at least about 1.71, at least about 1.72; at most about 0.71, at most about 0.72, at most about 1.71, at most about 1.72, at most about 4; about 0, about 0.1, about 0.2, about 0.25, about 0.33, about 0.5, about 0.67, about 0.71, about 0.72, about 0.75, about 0.8, about 1, about 1.5, about 1.71, about 1.72, about 2, about 2.5, about 3, about 3.5, about 4, or any ranges or values therebetween.

z may be about 0≤z≤ about 4, about 0.1≤z≤ about 4, about 0.2≤z≤ about 4, about 0.25≤z≤ about 4, about 0.33≤z≤ about 4, about 0.5≤z≤ about 4, about 0.67≤z≤ about 4, about 0.71≤z≤ about 4, about 0.72≤z≤ about 4, about 0.75≤z≤ about 4, about 0.8≤z≤ about 4, about 1≤z≤ about 4, about 1.5≤z≤ about 4, about 1.71≤z≤ about 4, about 1.72≤z≤ about 4, about 2≤z≤ about 4, about 2.5≤z≤ about 4, about 3≤z≤ about 4, about 3.5≤z≤ about 4; about 0≤z≤ about 1, about 0.1≤z≤ about 1, about 0.2≤z≤ about 1, about 0.25≤z≤ about 1, about 0.33≤z≤ about 1, about 0.5≤z≤ about 1, about 0.67≤z≤ about 1, about 0.71≤z≤ about 1, about 0.72≤z≤ about 1, about 0.75≤z≤ about 1, about 0.8≤z≤ about 1; about 0≤z≤ about 0.72, about 0.1≤z≤ about 0.72, about 0.2≤z≤ about 0.72, about 0.25≤z≤ about 0.72, about 0.33≤z≤ about 0.72, about 0.5≤z≤ about 0.72, about 0.67≤z≤ about 0.72, about 0.71≤z≤ about 0.72; about 0≤z≤ about 0.71, about 0.1≤z≤ about 0.71, about 0.2≤z≤ about 0.71, about 0.25≤z≤ about 0.71, about 0.33≤z≤ about 0.71, about 0.5≤z≤ about 0.71, about 0.67≤z≤ about 0.71; about 0≤z≤ about 0.1 about 0≤z≤ about 0.2, about 0≤z≤ about 0.25, about 0≤z≤ about 0.33, about 0≤z≤ about 0.5, about 0≤z≤ about 0.67, about 0≤z≤ about 0.71, about 0≤z≤ about 0.72, about 0≤z≤ about 0.75, about 0≤z≤ about 0.8, about 0≤z≤ about 1, about 0≤z≤ about 1.5, about 0≤z≤ about 1.71, about 0≤z≤ about 1.72, about 0≤z≤ about 2, about 0≤z≤ about 2.5, about 0≤z≤ about 3, about 0≤z≤ about 3.5; about 0.71≤z≤ about 0.72, about 0.71≤z≤ about 0.75, about 0.71≤z≤ about 0.8, about 0.71≤z≤ about 1, about 0.71≤z≤ about 1.5, about 0.71≤z≤ about 1.71, about 0.71≤z≤ about 1.72, about 0.71≤z≤ about 2, about 0.71≤z≤ about 2.5, about 0.71≤z≤ about 3, about 0.71≤z≤ about 3.5, about 0.71≤z≤ about 4; about 0.72≤z≤ about 0.75, about 0.72≤z≤ about 0.8, about 0.72≤z≤ about 1, about 0.72≤z≤ about 1.5, about 0.72≤z≤ about 1.71, about 0.72≤z≤ about 1.72, about 0.72≤z≤ about 2, about 0.72≤z≤ about 2.5, about 0.72≤z≤ about 3, about 0.72≤z≤ about 3.5, about 0.72≤z≤ about 4; about 1≤z≤ about 1.5, about 1≤z≤ about 1.71, about 1≤z≤ about 1.72, about 1≤z≤ about 2, about 1≤z≤ about 2.5, about 1≤z≤ about 3, about 1≤z≤ about 3.5, about 1≤z≤ about 4; at least about 0, at least about 0.71, at least about 0.72, at least about 1.71, at least about 1.72; at most about 0.71, at most about 0.72, at most about 1.71, at most about 1.72, at most about 4; about 0, about 0.1, about 0.2, about 0.25, about 0.33, about 0.5, about 0.67, about 0.71, about 0.72, about 0.75, about 0.8, about 1, about 1.5, about 1.71, about 1.72, about 2, about 2.5, about 3, about 3.5, about 4, or any ranges or values therebetween.

In some embodiments, x is 0.71. In some other embodiments, x is 1. In some embodiments, y is 1. In some other embodiments, y is 0.71. In some embodiments, z is 0.72. In some embodiments, n is 3.7. In some embodiments, A is K. In some embodiments, M_{A} is Cu. In some embodiments, M_{B} is Fe. In some embodiments, the metal hexacyanometalate is K_{0.71}Cu[Fe(CN)₆]_{0.72}·3.7H₂O.

The cathode may comprise a substrate. The substrate may be paper, porous paper, lens cleaning paper, current collector, film collector, carbon nanotube (CNT) film, carbon film or glassy carbon. The film collector may be a carbon nanotube (CNT) film.

The substrate may be first coated with the metal hexacyanoferrate or hydrates thereof, or the metal-doped metal hexacyanoferrate, or hydrates thereof, and subsequently coated with the glucose oxidase.

In some embodiments, the self-reducing polymer is an optionally substituted polypyrrole. In such an embodiment, the main specie involved in the self-reducing property of the optionally substituted polypyrrole is the pyrrole anion, upon release of the N—H proton. The optionally substituted polypyrrole may be unsubstituted, or substituted with at least one of alkyl, alkenyl, alkynyl, thioalkyl, cycloalkyl, cycloalkenyl, heterocycloalkyl, halo, F, Cl, Br, I, carboxyl, haloalkyl, haloalkynyl, hydroxyl, alkoxy, thioalkoxy, alkenyloxy, haloalkoxy, haloalkenyloxy, nitro, amino, nitroalkyl, nitroalkenyl, nitroalkynyl, nitroheterocyclyl, alkylamino, dialkylamino, alkenylamine, alkynylamino, acyl, alkenoyl, alkynoyl, acylamino, diacylamino, acylamido, acyloxy, alkylsulfonyloxy, heterocycloxy, heterocycloamino, haloheterocycloalkyl, alkylsulfenyl, alkylcarbonyloxy, alkylthio, acylthio, phosphorus-containing groups such as phosphono and phosphinyl, aryl, heteroaryl, alkylaryl, alkylheteroaryl, cyano, cyanate, isocyanate, carboxyl, carbonyl, —C(O)NH(alkyl), and —C(O)N(alkyl)₂. In some other embodiments, the optionally substituted polypyrrole is substituted with another self-reducing polymer. In some embodiments, the optionally substituted polypyrrole is unsubstituted. In some embodiments, the optionally substituted polypyrrole is polypyrrole.

The cathode and anode may each have a thickness that is less than the thickness of a contact lens. In some embodiments, the cathode and anode each have a thickness that is in a range of at least about 20 μm, at least about 54.05 μm; or about 20 m to about 100 μm, about 20 μm to about 90 μm, about 20 μm to about 80 μm, about 20 μm to about 70 μm, about 20 μm to about 60 μm, about 20 μm to about 54.05 μm, about 20 μm to about 50 μm, about 20 m to about 40 μm, about 20 m to about 30 μm, about 54.05 m to about 100 μm, about 54.05 m to about 90 μm, about 54.05 μm to about 80 μm, about 54.05 m to about 70 μm, about 54.05 μm to about 60 μm; or about 20 μm to about 100 μm, about 30 μm to about 100 μm, about 40 m to about 100 μm, about 50 m to about 100 μm, about 54.05 m to about 100 μm, about 60 m to about 100 μm, about 70 m to about 100 μm, about 80 m to about 100 μm, about 90 m to about 100 μm, about 20 μm to about 54.05 μm, about 30 μm to about 54.05 μm, about 40 μm to about 54.05 μm, about 50 μm to about 54.05 μm; or at most about 54.05 μm, at most about 100 μm; or about 20 μm, about 30 μm, about 40 μm, about 50 μm, about 54.05 μm, about 60 μm, about 70 μm, about 80 μm, about 90 μm, about 100 μm, or any ranges or values therebetween.

The present invention also provides a contact lens comprising the rechargeable battery disclosed herein.

The rechargeable battery may be embedded on the surface, or within the contact lens. The rechargeable battery may be embedded onto the contact lens in any method or fashion, so long as the vision of the user is not obstructed when the lens is worn.

The overall thickness of the contact lens comprising the rechargeable battery may be in a range of at least about 50 μm, at least about 90 μm, at least about 200 μm, at least about 250 μm; or about 50 μm to about 300 μm, about 50 m to about 275 μm, about 50 m to about 250 μm, about 50 m to about 225 μm, about 50 m to about 200 μm, about 50 m to about 175 μm, about 50 μm to about 150 μm, about 50 m to about 125 μm, about 50 μm to about 100 μm, about 50 μm to about 90 μm, about 50 μm to about 75 μm, about 90 m to about 300 μm, about 90 m to about 275 μm, about 90 m to about 250 μm, about 90 m to about 225 μm, about 90 m to about 200 μm, about 90 μm to about 175 μm, about 90 μm to about 150 μm, about 90 μm to about 125 μm, about 90 μm to about 100 μm, about 200 μm to about 300 μm, about 200 μm to about 275 μm, about 200 μm to about 250 μm, about 200 μm to about 225 μm, about 250 m to about 300 μm, about 250 μm to about 275 μm, about 275 μm to about 300 μm; or about 50 μm to about 300 μm, about 75 μm to about 300 μm, about 90 μm to about 300 μm, about 100 μm to about 300 μm, about 125 μm to about 300 μm, about 150 μm to about 300 μm, about 175 μm to about 300 μm, about 200 μm to about 300 μm, about 225 μm to about 300 μm, about 250 m to about 300 μm, about 275 μm to about 300 μm, about 50 m to about 250 μm, about 75 m to about 250 μm, about 90 m to about 250 μm, about 100 μm to about 250 μm, about 125 μm to about 250 μm, about 150 μm to about 250 μm, about 175 μm to about 250 μm, about 200 μm to about 250 μm, about 225 μm to about 250 μm, about 50 μm to about 200 μm, about 75 μm to about 200 μm, about 90 μm to about 200 μm, about 100 μm to about 200 μm, about 125 μm to about 200 μm, about 150 μm to about 200 μm, about 175 μm to about 200 μm, about 50 μm to about 90 μm, about 75 μm to about 90 μm; or at most about 50 μm, at most about 90 μm, at most about 200 μm, at most about 250 μm, at most about 300 μm; or about 50 μm, about 75 μm, about 90 μm, about 100 μm, about 125 μm, about 150 μm, about 175 μm, about 200 μm, about 225 μm, about 250 μm, about 275 μm, about 300 μm, or any ranges or values therebetween.

The cathode and the anode of the rechargeable battery are embedded at the outer edges or sides of the contact lens. Placing the cathode and anode at the outer edges or sides, i.e., not at the center of the contact lens, allow the lens to not occlude the vision of the user when the lens is worn. The other electrical components of the smart contact lens may similarly be placed at the outer edges to not occlude the vision of the user.

The rechargeable battery is advantageously capable of undergoing charging while being worn by a user using the user's tears as an electrolyte. The rechargeable battery undergoes is advantageously capable of charging while being worn by a user and without an external electrical power supply.

The contact lens may comprise a hydrogel, e.g., poly(hydroxyethyl methacrylate)(pHEMA), polymethylmethacrylate (PMMA), rigid gas permeable (RGP), silicone hydrogel, polyvinyl alcohol (PVA), or poly dimethyl siloxane (PDMS).

### STATEMENTS OF INVENTION

1. A rechargeable battery comprising:
(i) a cathode, the cathode comprising:
   metal hexacyanometalate or hydrates thereof, or metal-doped metal hexacyanometalate or hydrates thereof, and
   glucose oxidase; and
(ii) an anode comprising a self-reducing polymer.

2. The rechargeable battery of statement 1, wherein both the cathode and anode undergo self-charging.

3. The rechargeable battery of statement 1, wherein both the cathode and anode undergo self-charging in an electrolyte comprising glucose.

4. The rechargeable battery of statement 3, wherein the cathode self-charges via oxidation of the glucose by the glucose oxidase to produce H₂O₂ which oxidizes the metal hexacyanometalate or hydrates thereof, or metal-doped metal hexacyanometalate or hydrates thereof.

5. The rechargeable battery of statement 3, wherein the electrolyte is selected from the group consisting of human tears, animal tears, and contact lens solution.

6. The rechargeable battery of statement 1, wherein the anode self-charges via self-reduction of the self-reducing polymer in the presence of hydroxide ions.

7. The rechargeable battery of claim 1, wherein the metal of the metal hexacyanometalate, or hydrates thereof, is selected from the group consisting of copper, manganese, iron, cobalt, nickel, and zinc;
wherein the hexacyanometalate of the metal hexacyanometalate, or hydrates thereof, or the hexacyanometalate of the metal-doped metal hexacyanometalate, or hydrates thereof, is selected from the group consisting of hexacyanoferrate, hexacyanidocobaltate, hexacyanochromate, hexacyanomanganate, hexacyanoruthenate;
wherein the metal hexacyanometalate of the metal-doped metal hexacyanometalate, or hydrates thereof, is selected from the group consisting of copper hexacyanometalate, manganese hexacyanometalate, iron hexacyanometalate, cobalt hexacyanometalate, nickel hexacyanometalate, and zinc hexacyanometalate; or wherein the metal-doped metal hexacyanometalate, or hydrates thereof, is selected from the group consisting of lithium-doped, sodium-doped, potassium-doped, rubidium-doped, caesium-doped, magnesium-doped, calcium-doped, zinc-doped, and aluminium-doped metal hexacyanometalate, or hydrates thereof.

8. The rechargeable battery of statement 1, wherein the cathode comprises a substrate, wherein the substrate is first coated with the metal hexacyanometalate or hydrates thereof, or metal-doped metal hexacyanometalate, or hydrates thereof, and subsequently coated with the glucose oxidase.

9. The rechargeable battery of statement 1, wherein the substrate is selected from the group consisting of paper, porous paper, lens cleaning paper, current collector, film collector, carbon nanotube (CNT) film carbon film and glassy carbon.

10. The rechargeable battery of statement 1, wherein the self-reducing polymer is an optionally substituted polypyrrole.

11. The rechargeable battery of statement 10, wherein the optionally substituted polypyrrole is unsubstituted.

12. The rechargeable battery of statement 10, wherein the optionally substituted polypyrrole is substituted with at least one substituent selected from a group consisting of alkyl, alkenyl, alkynyl, thioalkyl, cycloalkyl, cycloalkenyl, heterocycloalkyl, halo, F, Cl, Br, I, carboxyl, haloalkyl, haloalkynyl, hydroxyl, alkoxy, thioalkoxy, alkenyloxy, haloalkoxy, haloalkenyloxy, nitro, amino, nitroalkyl, nitroalkenyl, nitroalkynyl, nitroheterocyclyl, alkylamino, dialkylamino, alkenylamine, alkynylamino, acyl, alkenoyl, alkynoyl, acylamino, diacylamino, acylamido, acyloxy, alkylsulfonyloxy, heterocycloxy, heterocycloamino, haloheterocycloalkyl, alkylsulfenyl, alkylcarbonyloxy, alkylthio, acylthio, phosphorus-containing groups such as phosphono and phosphinyl, aryl, heteroaryl, alkylaryl, alkylheteroaryl, cyano, cyanate, isocyanate,, carboxyl, carbonyl, —C(O)NH(alkyl), and —C(O)N(alkyl)₂.

13. The rechargeable battery of statement 1, wherein the cathode and anode each have a thickness that is less than the thickness of a contact lens.

14. The rechargeable battery of statement 1, wherein the cathode and anode each have a thickness that is less than 80 μm.

15. A contact lens comprising the rechargeable battery of statement 1.

16. The contact lens of statement 15, wherein the rechargeable battery is embedded within the contact lens.

17. The contact lens of statement 15, wherein the cathode and the anode of the rechargeable battery are embedded at the outer sides or edges of the contact lens.

18. The contact lens of statement 15, wherein the rechargeable battery undergoes charging while being worn by a user using the user's tears as an electrolyte.

19. The contact lens of statement 15, wherein the rechargeable battery undergoes charging while being worn by a user and without an external electrical power supply.

20. The contact lens of statement 15, wherein the contact lens comprises poly(hydroxyethyl methacrylate) (pHEMA), polymethylmethacrylate (PMMA), rigid gas permeable (RGP), silicone hydrogel, polyvinyl alcohol (PVA), or poly dimethyl siloxane (PDMS).

### EXAMPLES

Non-limiting examples of the invention and comparative examples will be further described in greater detail by reference to specific examples, which should not be construed as in any way limiting the scope of the invention.

### Material and Methods

GOx (from Aspergillus niger, 100,000-250,000 units/g) and BSA (heat shock fraction, 98%), were purchased from Sigma-Aldrich. CNT (P3-SWNT) was purchased from Carbon Solution.

### Example 1: Concept

FIG. 1 illustrates a rechargeable battery of the present invention undergoing charging and discharging and its application in a smart contact lens. The battery discharges while supplying power to a smart contact lens and is then charged while stored in a case with a charging solution comprising glucose (FIG. 1a). The battery can be charged by simple immersion in the charging solution without requiring external electrical power.

In the present examples, a rechargeable battery comprising copper hexacyanoferrate (CuHCFe) coated with a layer of GOx as cathode may be charged by immersion in a glucose solution. The GOx oxidizes glucose to gluconic acid while simultaneously reducing oxygen to H₂O₂. The H₂O₂ then works as an oxidizing agent of CuHCFe, thus charging the cathode. Meanwhile, the anode in the rechargeable battery comprises polypyrrole (PPy) and charges by self-reduction of PPy by the nucleophilic attack of hydroxide ions (FIG. 1b). This self-charging process can still proceed even at low concentrations of hydroxide ions present in, e.g. neutral solutions. The discharging mechanism of the battery is the cation intercalation of CuHCFe at the cathode and the anion coordination to PPy at the anode. The chemical reaction equations are further elaborated below.

Hydrogen peroxide is produced by the enzymatic reaction of glucose oxidase with glucose and oxygen. The hydrogen peroxide acts as an oxidizing agent and CuHCFe is oxidized while de-intercalating cations. The oxidized PPy is reduced by the nucleophilic attack of hydroxide ions. The charging reactions are as follows:

For charging (i.e., oxidizing) of the cathode (CuHCFe),

$$Glucose + O 2 {\to }^{Glucose oxidase} Gluconic acid + H 2 O 2$$

$$KCuHCFe ( II ) + 1 / 2 H 2 O 2 + H + \to K ++ CuHCFe ( III ) + H 2 O$$

For charging (i.e., reducing) of the anode (PPy),

PPy·Cl−+OH−→PPy·OH−+Cl−

PPy·OH−→PPy−OH+H+

The discharging mechanism of the battery is the cation intercalation of CuHCFe at the cathode and the anion coordination to PPy at the anode. The discharging reactions are as follows:

For discharging of the cathode,

CuHCFe+K++e−→KCuHCFe

For discharging of the anode,

PPy+Cl−→PPy·Cl−+e−

### Example 2: Synthesis of Cathode and Anode

### Example 2a: Preparation of Active CuHCFe and PPy Material

To prepare the CuHCFe active material, 120 ml of 40 mM Cu(NO₃)₂ and 120 ml of 20 mM K₃Fe(CN)₆ were added dropwise to 60 ml of DI water at 40° C. with stirring. Precipitated CuHCFe remained in the beaker without stirring for 24 hours and was purified by centrifuging and redispersing in DI water. The CuHCFe powders were then dried in a vacuum oven.

For preparing the PPy active material, 50 ml of 0.6 M Na₂S₂O₈ was added dropwise to 150 ml of 0.2 M pyrrole at 0° C. with stirring. PPy was separated from the solution by vacuum filtration and washed with DI water several times. The PPy was redispersed in isopropyl alcohol and cut into small pieces using a hand homogenizer (3000, Dremel) because freshly synthesized PPy contained large powders. The PPy active material was finally obtained by centrifuge and vacuum drying.

### Example 2b: Preparation of Cathode and Anode

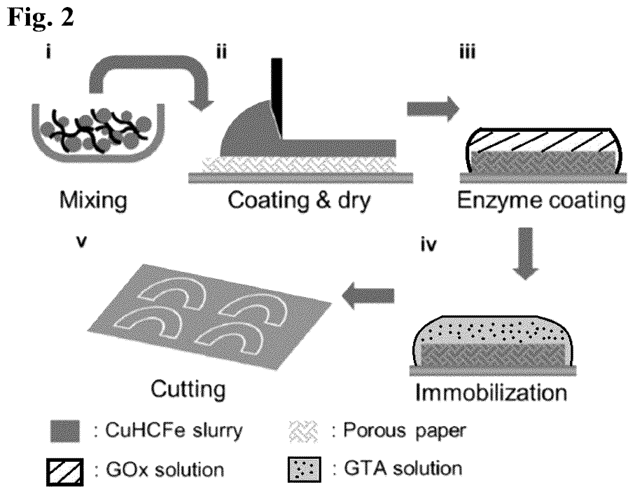

FIG. 2 illustrates the fabrication of the CuHCFe/GOx cathode. Porous paper (lens cleaning paper, Whatman) was used as a substrate for the electrodes to enhance their mechanical strength and flexibility. In addition, the porous paper allowed easy handling of the free-standing film electrodes without damaging the electrodes during integration with the contact lens.

To synthesise the electrodes, a slurry comprising the active material (CuHCFe or PPy), carbon nanotubes, carbon fibers (CFs), polyvinylidene fluoride (PVDF), and N-methyl-2-pyrrolidone (NMP; FIG. 2i) in an 8:1:3:1:80 weight ratio was first prepared, with mixing performed in a mixer (AR-100, Thinky). The CFs were added as additional conductive materials to improve the electrical conductivity of the electrodes. The porous paper was placed on a glass substrate, and the prepared slurries were coated onto the porous paper using a doctor blade (FIG. 2ii). The slurry-coated electrodes were then dried in a vacuum oven at 40° C. for 24 hours.

GOx was immobilized on the CuHCFe cathode by cross-linking GOx with bovine serum albumin (BSA) using glutaraldehyde (GTA). To do so, GOx and BSA were dissolved in a 2 wt % PVA solution with a mass ratio of 1:0.5:10. The GOx/BSA mixture was then coated onto the CuHCFe electrode with an areal mass loading of 1 mg cm⁻² of GOx. The coated CuHCFe/GOx cathode was then dried in a vacuum chamber at room temperature (FIG. 2iii) and a GTA solution (2.5 wt %) was dropped on the electrode with an areal mass of 10 mg cm⁻². After incubating for 1 hour at room temperature, the electrode was washed with DI water and dried in the vacuum chamber at room temperature (FIG. 2iv).

### Example 2c: Preparation of Smart Contact Lens with Rechargeable Battery

The electrodes were each cut into c-shapes with an inner diameter of 8 mm and an outer diameter of 16 mm. Carbon wires were connected to the electrodes using a carbon slurry made by mixing carbon black, PVDF, and NMP. The electrodes were then embedded into a contact lens made of 2-HEMA based hydrogel (FIG. 2v). The hydrogel was polymerized using a UV-initiator, and 15 mm diameter molds, being the size of conventional contact lenses, were used. The diameter of the electrodes were larger than the diameter of the molds to fit the electrodes to the hemisphere.

### Example 3: Characterisation

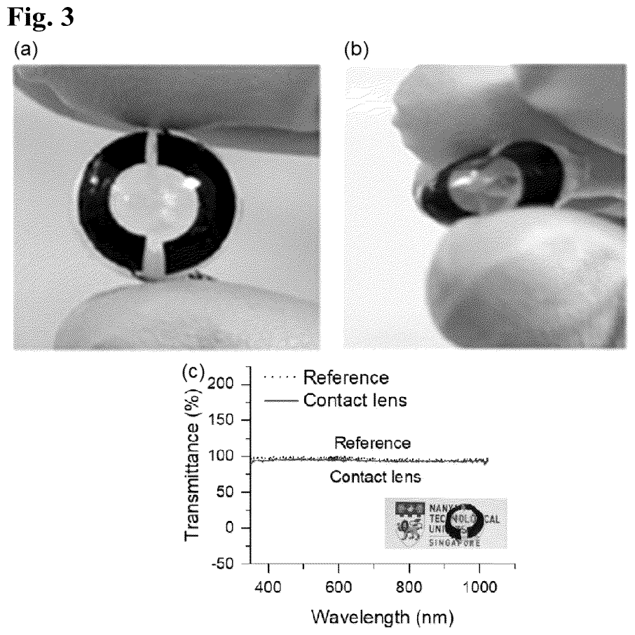

FIG. 3a shows the contact lens embedded with the rechargeable battery, while FIG. 3b shows the same contact lens under bending. The field of vision and the flexibility of the contact lens battery were confirmed, as shown in FIGS. 3a and 3b. Because the electrodes were placed at the outer sides/edges of the contact lens, the vision of the eye was not obstructed. The miniaturization of electrical parts for smart contact lenses allows enough space for integrating the electronics and sensors with the battery.

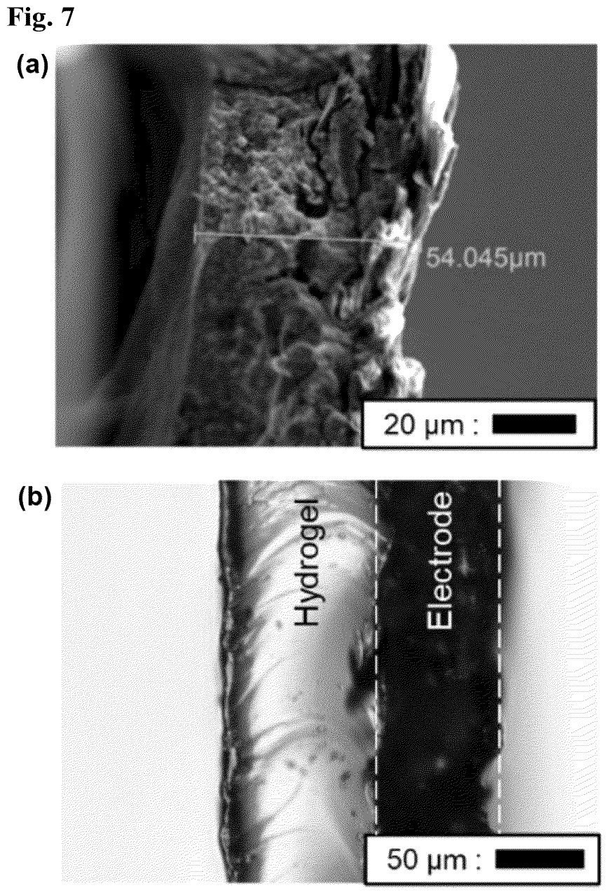

FIG. 7b further shows a cross-sectional image of the smart contact lens with the battery embedded. The electrode was fully covered by hydrogel and the overall thickness was 90 μm, which is thinner than conventional contact lenses (200 μm). The transmittance of the smart contact lens was evaluated using UV-vis spectroscopy and shown in FIG. 3c. The prepared lens had nearly 100% transmittance, indicating a satisfactory transparency level despite the embedding of the rechargeable battery.

Additionally, the smart contact lens was robust enough to withstand folding (FIG. 3b). To further evaluate the mechanical performance of the smart contact lens under external bending stress, the smart contact lens was subjected to bending by a mechanical tester and evaluated for its discharging performance.

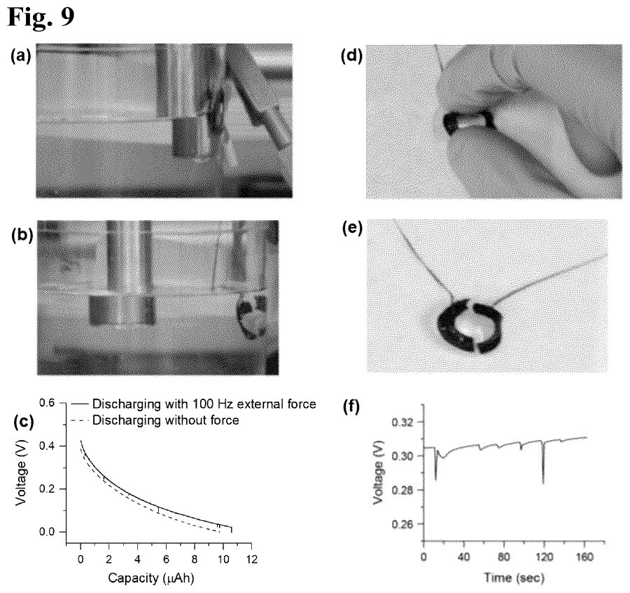

The smart contact lens evaluated under frequent external bending by a mechanical tester (FIGS. 9a and 9b) showed no change in battery capacities when an external force was applied, as compared to a reference lens without force (FIG. 9c). Even after manual deformation by fingers (FIGS. 9d and 9e), the small changes in open circuit voltage (OCV) of the battery indicated the quick recovery of the battery after external disturbances (FIG. 9f).

### Example 3a: Structural Characterisation

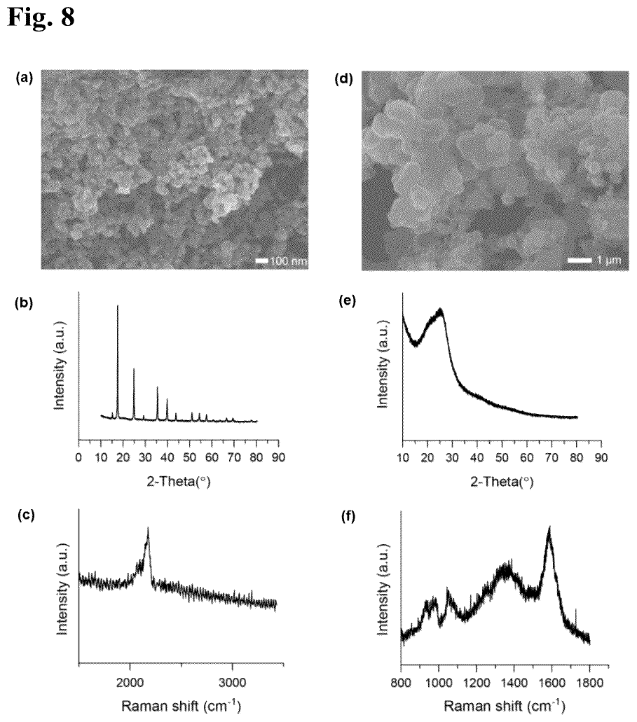

The structural analysis of the CuHCFe and PPy active material were conducted using scanning electron microscope (SEM), X-ray powder diffraction (XRD), and Raman, respectively, as shown in FIG. 8.

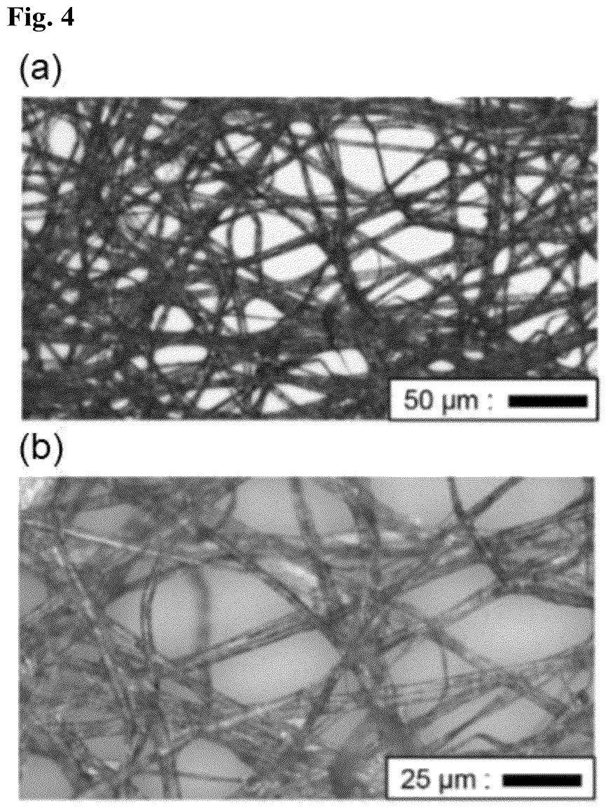

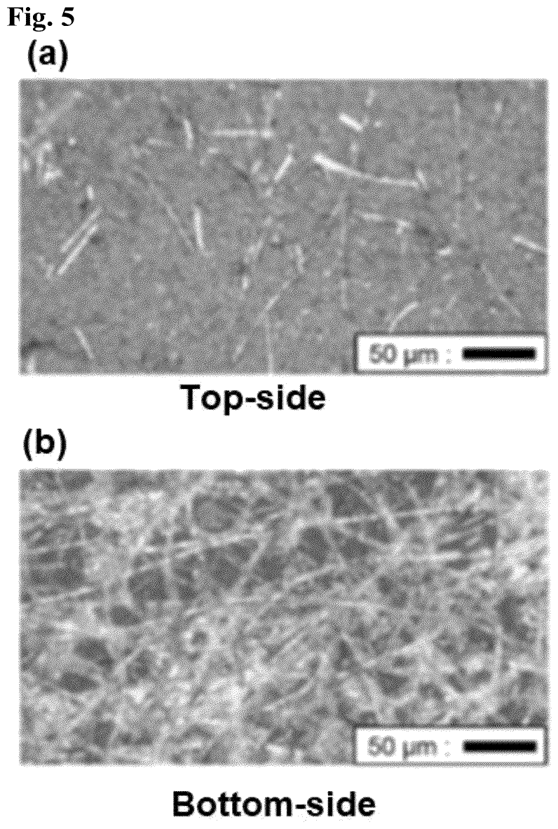

The microscopic structure of the porous paper is shown in FIGS. 4a and 4b. In comparison, the microscopic images of the top-side and bottom-side of the CuHCFe electrode indicate that the porous paper works as a structural material to hold the CuHCFe mixtures (FIGS. 5a and 5b). FIG. 5a showing the top-side image of the CuHCFe electrode on porous paper, indicates that the CuHCFe active material was well distributed on the porous paper to form an electrode of about 54 μm in thickness.

### Example 3b: Conductivity

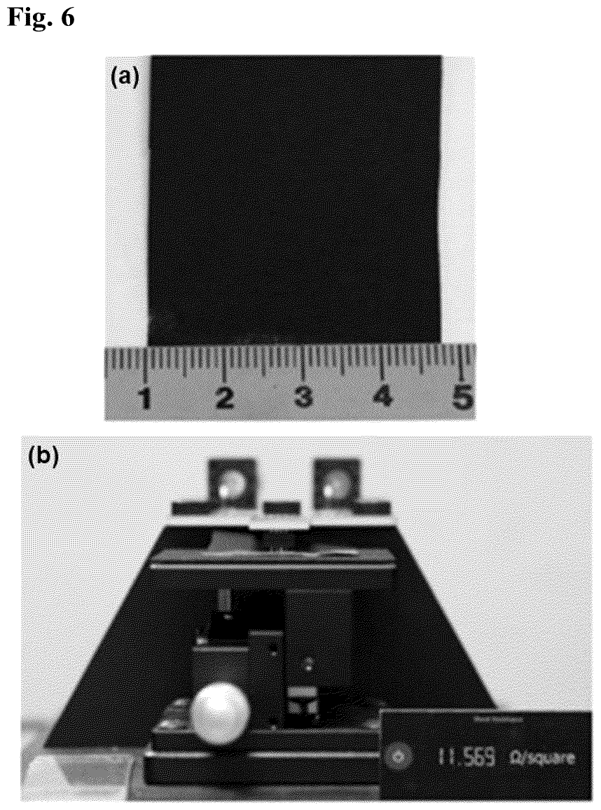

The conductivity of the electrodes prepared was measured using a 4-probe method using an Ossila 4-point probe equipment. During the measurement, the outer 2 probes apply electric current while another 2 probes measured the voltage. The four probes were aligned in a straight line with the same distance between adjacent probes. The resistance of the material may be measured by calculating the voltage drop and current flow along the sample. FIG. 6a shows the PPy anode, and FIG. 6b shows the resistance measurement of the same PPy anode using the 4-probe method. The resistance of the CuHCFe cathode without the immobilised GOx was measured in the same way. Sheet resistances of the cathode and anode were measured to be 55.9 Ω/sq and 11.6 Ω/sq, respectively. Measurements indicated the PPy anode as having higher conductivity than the CuHCFe/GOx cathode, likely because PPy is a conductive polymer.

### Example 3b: Electrochemical Characterisation

Half-cell tests of the cathode and anode were first performed to characterize the charging performance. For the half-cell tests, a three-electrode system was built using CuHCFe or PPy as the working electrode, Ag/AgCl in 4 M KCl as the reference electrode, and activated carbon as the counter electrode. An artificial tear solution composed of 0.2 M NaCl and 0.15 M KCl was used for discharging while a 0.1 M glucose solution was used for charging. All electrochemical measurements were conducted by potentiostat/galvanostat (VSP-300, BioLogic).

The cathode and anode were discharged at a current of 100 μA and stopped at voltages of 0.4 V (vs Ag/AgCl) and 0.5 V (vs Ag/AgCl), respectively. The electrodes were then washed with DI water using a wash bottle and charged in the glucose solution for 20 hours at a temperature of 36.5° C. For full cell tests, a two electrode system was built with CuHCFe as the working electrode and PPy as the counter and reference electrodes. The battery was discharged at a current of 100 μA and stopped at a voltage of 0 V. After washing with DI water, the battery was charged in the glucose solution for 24 hours at a temperature of 36.5° C.

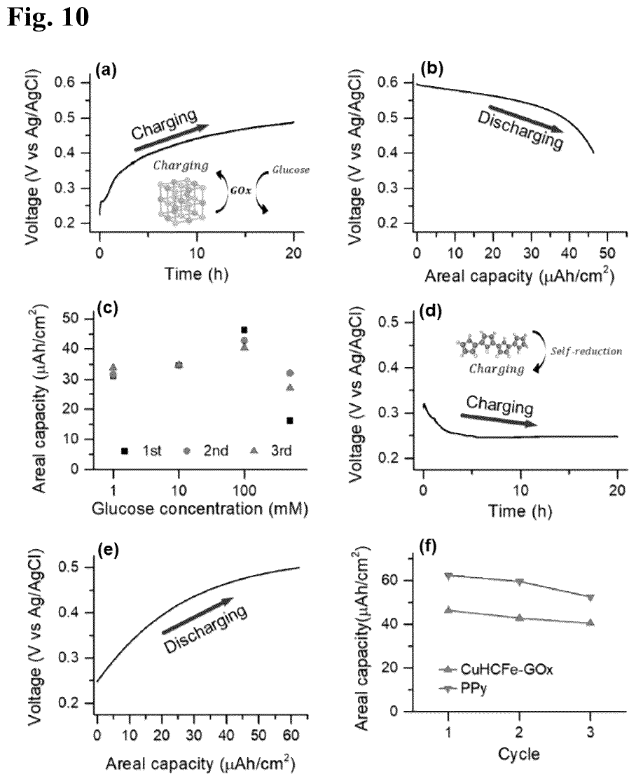

FIG. 10 shows the results of enzymatic oxidation of the cathode and self-reduction of the anode. The open circuit voltage (OCV) of the CuHCFe electrode in the glucose solution was measured in real-time and shown in FIG. 10a. The discharging capacity at a current of 100 μA (200 μA cm⁻²) was 46.3 gAh cm⁻², as shown in FIG. 10b. The OCV of the CuHCFe/GOx electrode increased from 0.489 V (vs Ag/AgCl) to 0.605 V (vs Ag/AgCl) when switched from the charging solution to the tear solution. FIG. 10c shows the discharging capacities of the CuHCFe electrode for different concentrations of glucose in the charging solution, showing uniform discharging capacities across all three runs and up to 100 mM glucose concentration.

Typically, the formal potential of CuHCFe is related to the type of cations present and their concentration. In general, a higher atomic number of the alkali metal ion and a higher concentration of the salt leads to a higher formal potential of CuHCFe. The formal potential (E⁰) of CuHCFe can be estimated as the mean of the E_{pc} (cathodic peak potential) and Eₚₐ (anodic peak potential), as described in the following equation.

$${E}^{{0}^{′}} = \frac{{E}_{pc} + {E}_{pa}}{2}$$

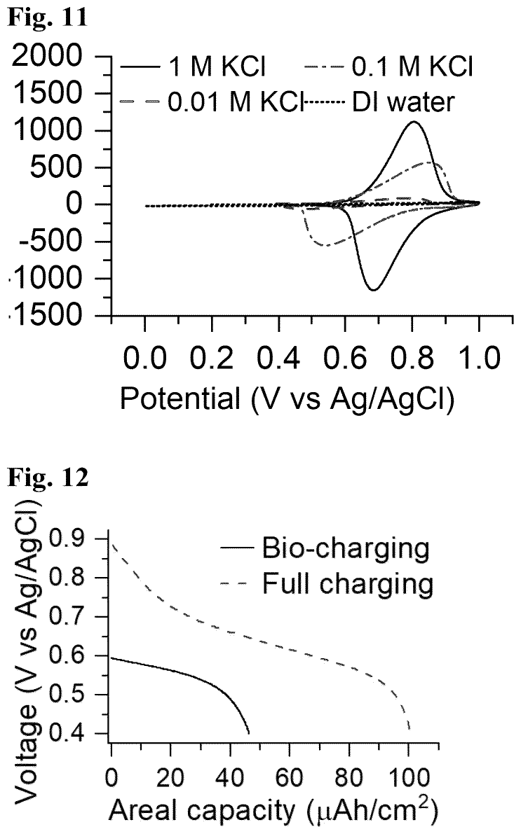

To estimate this formal potential of the CuHCFe cathode, cyclic voltammetry (CV) was also performed on the CuHCFe cathode at various KCl concentrations, with the curves shown in FIG. 11. The formal potential of the CuHCFe was investigated in (i) DI water, (ii) 0.01 M KCl, (iii) 0.1M KCl, and (iv) 1 M KCl. Accordingly, the potentials were measured as (i) 0.603 V, (ii) 0.639 V, (iii) 0.695 V, and (iv) 0.745 V respectively. Because no salt was added to the charging solution, the potential of the CuHCFe in the charging solution was lower than in the tear solution.

### Glucose Concentration

Different concentrations of glucose in the charging solution were also tested, with results shown in FIG. 10c. Higher glucose concentrations up to 100 mM led to higher discharging capacities, but higher concentrations (e.g., 500 mM) did not increase the capacity further. At up to 100 mM glucose concentration, the rate of reaction of GOx with glucose was governed by the glucose concentration of the solution, whereas above 100 mM the glucose supply from the solution to GOx was saturated, and thus the rate was limited by the activity and number of enzymes present. Nonetheless, the results show that the CuHCFe electrode could be charged by the enzymatic activity of GOx, with the 100 mM glucose solution providing the best charging capacity.

The initial voltage of discharging curve of the CuHCFe in the tear solution indicated that the CuHCFe electrode was not fully charged by charging, possibly because of the low electrochemical potential of H₂O₂, the discharging curve being shown in FIG. 12.

The standard electrode potential of H₂O₂ is 1.78 V (vs SHE), but the actual electrode potential of H₂O₂ at the electrode is lower because of the low concentrations of H₂O₂ and protons in the solution. The electrode potential of H₂O₂ is further discussed below.

The standard electrode potential of H₂O₂+2H⁺+2e⁻↔2H₂O is 1.78 V (vs SHE). The Nernst equation for the redox reaction is provided below:

$$\begin{matrix}E = {E}_{0} - \frac{RT}{zF} ln ( \frac{{a}_{Red}}{{a}_{Ox}} ) = \\ 1.78 - \frac{( 8.314 J \cdot {K}^{- 1} {mol}^{- 1} ) ( 298.15 K )}{( 2 ) ( 96485 s \cdot A \cdot {mol}^{- 1} )} ln ( \frac{1}{{[ {H}_{2} {O}_{2} ] [ {H}^{+} ]}^{2}} ) \\ = 1.78 - \frac{( 8.314 J \cdot {K}^{- 1} {mol}^{- 1} ) ( 298.15 K )}{( 2 ) ( 96485 s \cdot A \cdot {mol}^{- 1} )} ln ( \frac{1}{{[ {H}_{2} {O}_{2} ] [ {H}^{+} ]}^{2}} ) \\ = 1.78 + ( 0.0295 ) log ( {[ {H}_{2} {O}_{2} ] [ {H}^{+} ]}^{2} ) ( V vs SHE )\end{matrix}$$

Since the glucose solution is neutral,

$$\begin{matrix}E = 1.78 + ( 0.0295 ) log ( {( {10}^{- 7} )}^{2} ) + ( 0.0295 ) log ( [ {H}_{2} {O}_{2} ] ) \\ = 1.78 + ( - 0.413 ) + ( 0.0295 ) log ( [ {H}_{2} {O}_{2} ] ) \\ = 1.367 + ( 0.0295 ) log ( [ {H}_{2} {O}_{2} ] ) ( V vs SHE )\end{matrix}$$

Assuming the concentration of H₂O₂ to be about 0.5 mM when the concentration of glucose is 100 mM,

$$E = 1.27 ( V vs SHE ) = 1.07 ( V vs Ag / AgCl in 4 M KCl ) ,$$

which is about 0.20 V lower than its standard electrode potential.

However in practice, the H₂O₂ concentration in the CuHCFe electrode may not precisely match the approximation of 0.5 mM H₂O₂ because actual experimental conditions, such as the density of GOx and immobilization method, will differ. It is possible that the H₂O₂ concentration may be similar to or even lower than 0.5 mM when the H₂O₂ reaches the CuHCFe electrode by diffusion. While the actual concentration and accordingly the electrode potential of the H₂O₂ may not high enough to induce the full oxidation of CuHCFe by itself, there are still various methods to increase the charging capacity: (i) increasing the H₂O₂ concentration and (ii) decreasing the potential of the CuHCFe electrode. The (i) H₂O₂ concentration can be increased by optimizing the GOx activity and (ii) the potential of the CuHCFe electrode can be decreased by reducing the salt concentration.

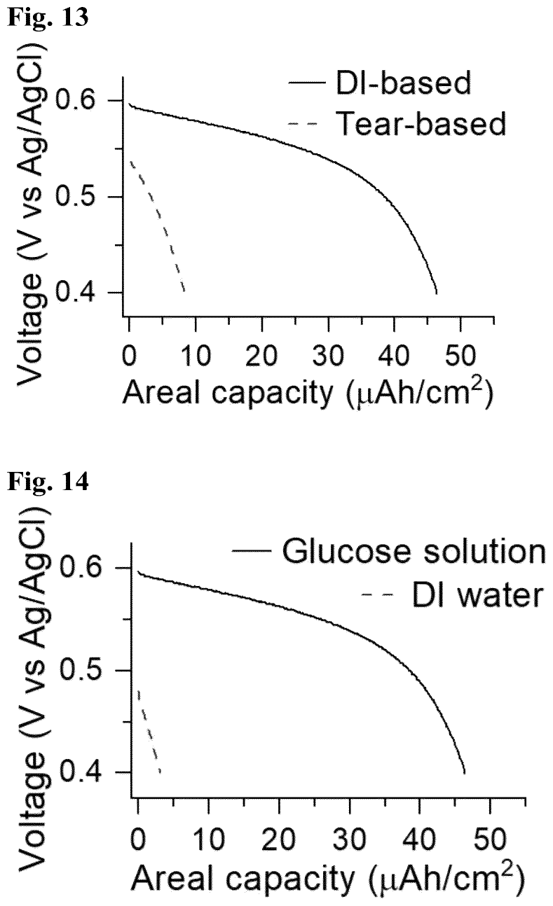

Therefore, the glucose concentration was adjusted to maximize the H₂O₂ concentration and a DI-water based glucose solution was used to minimize the salt concentration. To verify the effect of salts in the charging solution on the charging process, the CuHCFe electrode was charged in an artificial-tear-based glucose solution composed of 0.2 M NaCl, 0.15 M KCl, and 100 mM glucose. This experiment showed that the CuHCFe electrode charged in the artificial-tear-based glucose solution had a lower charging capacity than when it was charged in the DI-water-based glucose solution (FIG. 13). Thus a salt-free glucose solution was used for subsequent charging processes.

As a control, the CuHCFe was charged in pure DI water to verify the self-oxidation of CuHCFe (FIG. 14). The CuHCFe electrode was immersed in DI water for 20 hours and was then discharged. FIG. 14 showed that the discharging capacity of the CuHCFe electrode charged by self-oxidation was negligible compared with its discharging capacity when charged in a glucose solution, showing the advantages of using a glucose solution to charge the rechargeable battery.

The PPy anode was discharged (i.e., oxidized) in the artificial tear solution and charged in the charging solution used for the oxidation of CuHCFe. FIG. 10d showed that the real-time OCV of the PPy electrode in the charging solution decreased gradually, indicating that the PPy had been reduced. After 20 hours of charging, the PPy electrode was discharged in an artificial tear solution, demonstrating a discharging capacity of 62.4 μAh cm⁻² at a current of 100 μA (200 μA cm⁻²), as shown in FIG. 10e.

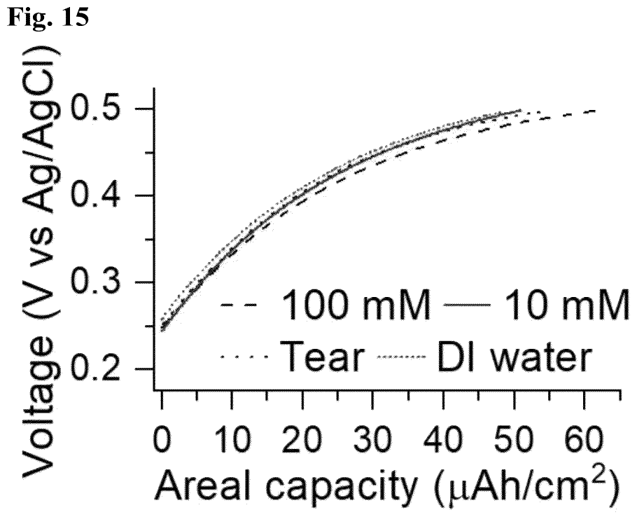

The dependence of self-reduction of PPy on the solution was confirmed by measuring its OCV in different solutions of various glucose concentrations, artificial tears, and DI water (FIG. 15). The results from FIG. 15 showed that the self-reduction behavior of PPy was not related to the concentration of glucose nor the salt content of the solutions. Because the nucleophilic attack on PPy depended on the pH level of the solution, the PPy electrode charging process may be improved by using a more basic charging solution. However, the pH level of the charging solution was instead adjusted to around 7 to ensure the maximum enzymatic activity of GOx and maximise biocompatibility for human usage. The eletrodes may be rinsed prior to insertion into the eye.

Charging and discharging cycles of the CuHCFe and PPy electrodes were observed to verify the stability of the electrodes. FIG. 10f showed persisting discharging capacities of the electrodes, indicating that the enzymatic activity of GOx and the self-reduction of PPy were reversible for several cycles. The longer cycle performance of the electrodes is discussed in the full-cell tests in the following Examples.

### Example 4: Charging and Discharging

After characterizing the charging performance of the CuHCFe/GOx and PPy electrodes, the charging performance of a full cell containing these two electrodes was characterized. The rechargeable contact lens battery (Example 2c) consisted of a CuHCFe/GOx cathode and a PPy anode embedded into a contact lens made of ultraviolet (UV)-polymerized poly(hydroxyethyl methacrylate) (pHEMA) hydrogel. pHEMA is widely used as a hydrogel polymer for contact lens fabrication. Additionally, because pHEMA can be polymerized at room temperature, its use avoids high-temperature polymerisation processes that could destabilize the GOx enzymes.

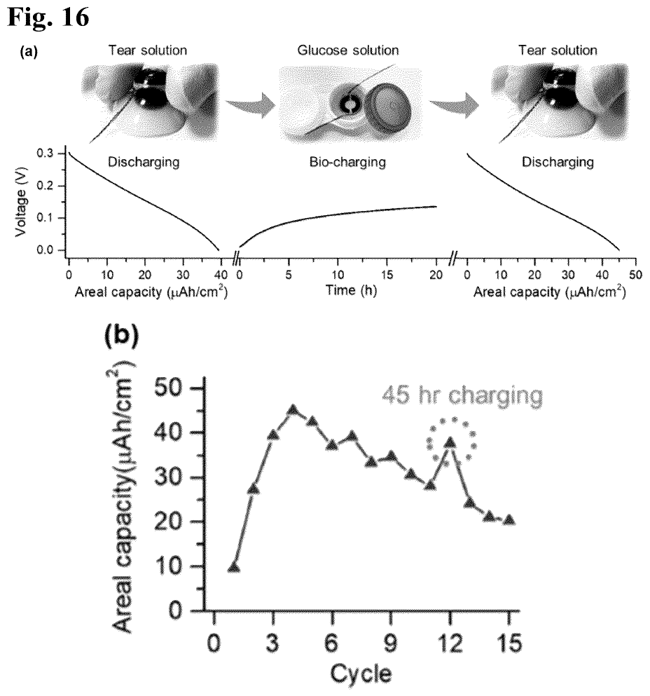

FIG. 16a shows charging and discharging the cycles of the full battery cell in a glucose charging solution and an artificial tear solution respectively. The battery was charged for 20 hours, during which the charging process was monitored by the battery's real-time OCV, followed by discharging at a current of 100 μA (166 μA cm⁻²). As discussed in Example 3b, the OCV of the battery increased when it was moved from the charging solution to the tear solution because the formal potential of CuHCFe in the tear solution is higher than that in the DI-water based glucose solution. The OCV and discharging capacity of the battery in the tear solution were 0.310 V and 27.1 μAh (45 μAh cm⁻²), respectively.

The charging and discharging cycles were investigated and shown in FIG. 16b. The areal capacity of the battery increased in the initial cycles, peaking in the full cell's fourth cycle (45 μAh cm⁻²) before decreasing in the subsequent cycles. It is postulated that the hydrogel may have influenced the initial charging cycles because the hall-cell tests where the CuHCFe/GOx half-cell was not embedded in hydrogel did not show a similar increase in capacity during its initial cycles.

It is postulated that the degradation of GOx over time resulted in a decrease in the charging capacity. However, the cyclic performance may be improved by enhancing the biomolecules' stability, by enhancing the enzymatic reactions to produce higher concentrations of H₂O₂, or by optimizing the structure of the electrodes to improve the diffusion transport of H₂O₂ from the GOx layer to CuHCFe.

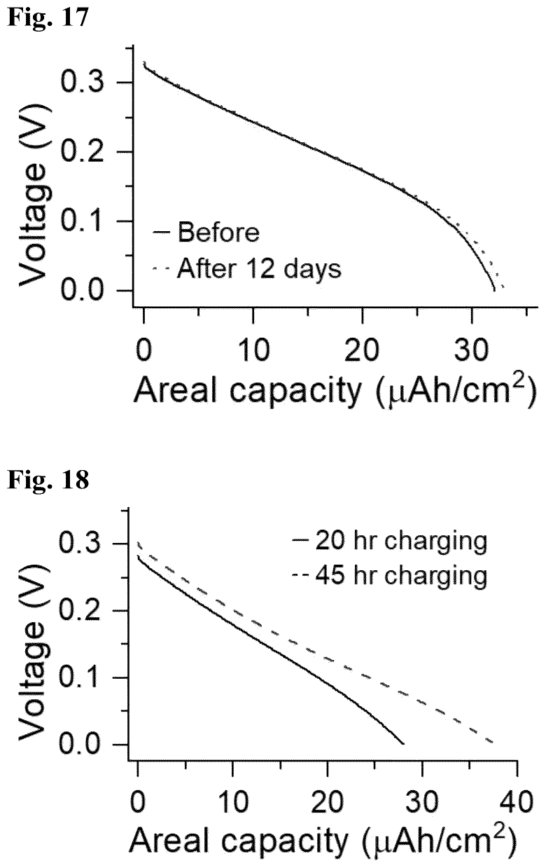

For example, the lifetime of GOx enzymes can be extended by storing them below room temperature, and accordingly the batteries containing GOx enzymes can be refrigerated or stored at below room temperature without degrading their charging capacity. To demonstrate this, the rechargeable battery was stored in a refrigerator for 12 days, and subject to the same charging and discharging cycles, with results shown in FIG. 17. The battery maintained the same discharging capacity as compared to before it was refrigerated, illustrating the stability of the battery at below room temperature, as well as showing how the charging capacity may be improved by storing the battery at below room temperatures.

Alternatively, the capacity of the battery may be improved simply by charging the battery for a longer duration, e.g. for 45 hours up from 20 hours, as shown in FIG. 16b and FIG. 18. At the 10^{th} cycle (FIG. 16b), the battery was charged for 45 hours and reached an areal capacity of 37.6 μAh cm⁻², which was higher than at the previous ninth cycle (28 μAh cm⁻²) that had been charged for 20 hours.

Notwithstanding, the excellent performance of the rechargeable battery over 15 cycles is sufficient to demonstrate the charging and discharging performance of the present rechargeable battery.

### Bio-Compatibility

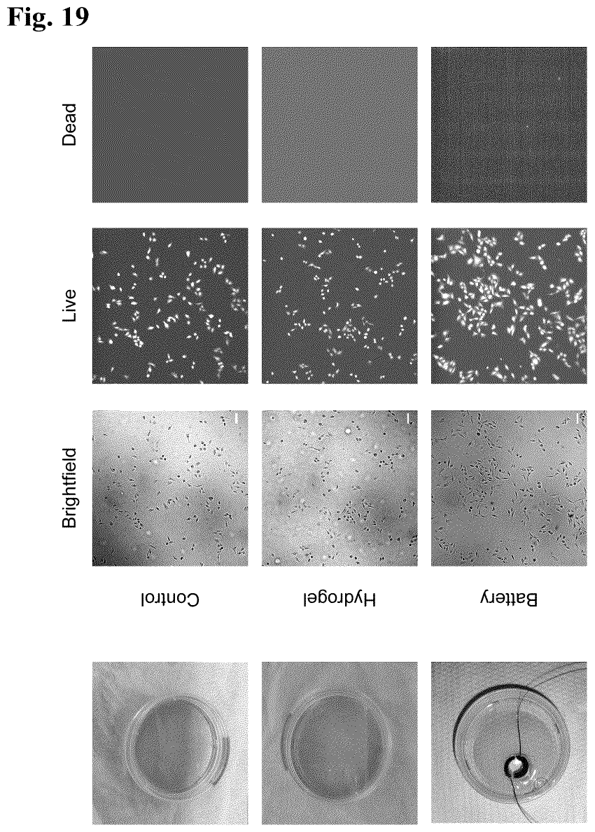

The biocompatibility of the battery was investigated by conducting cytotoxicity tests on a cultured Human Bone Osteosarcoma Epithelia cell line (U2OS cells) while the battery was charged and discharged for 24 hours. The similar observations in the microscope images of live and dead cells across the control, hydrogel experiment and battery experiment showed that the battery was bio-compatible with human cells, as shown in the FIG. 19.

Comparing Charging with Electrical Charging

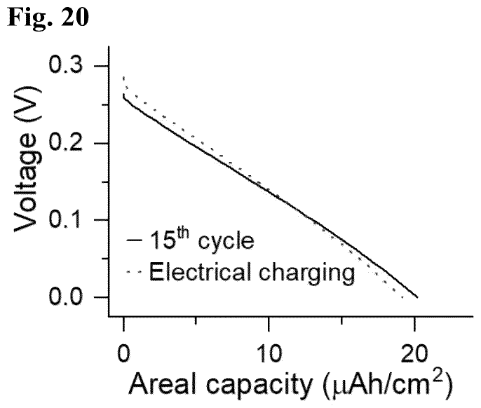

The charging of the battery was compared with conventional electrical charging of the battery, as shown in FIG. 20, with the battery now charged by applying an electrical current. The battery was charged in the tear solution at a current of 100 μA until the voltage of the battery reached 0.3 V. The discharging curves of the charged and electrically charged batteries show that the charging and electrical charging produced similar outputs, showing that the performance of the battery was comparable to when it was externally charged by an external electrical source.

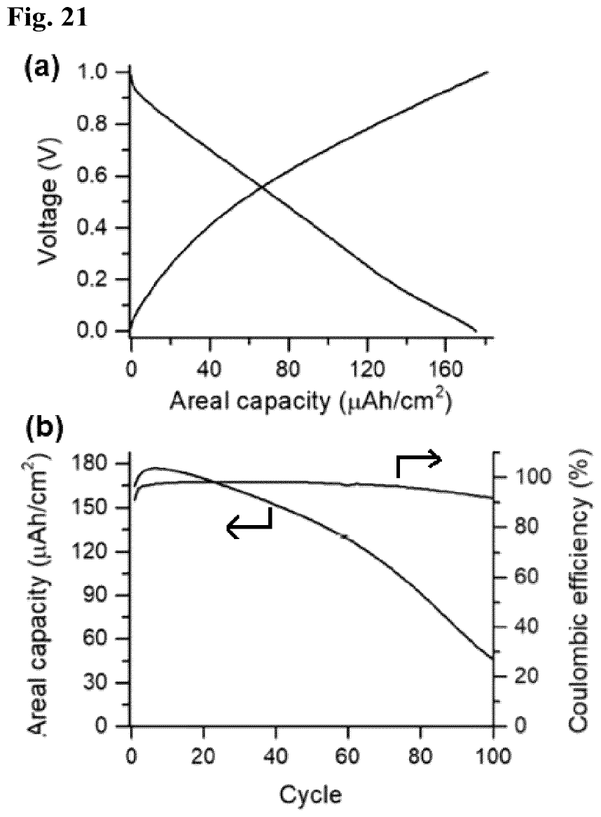

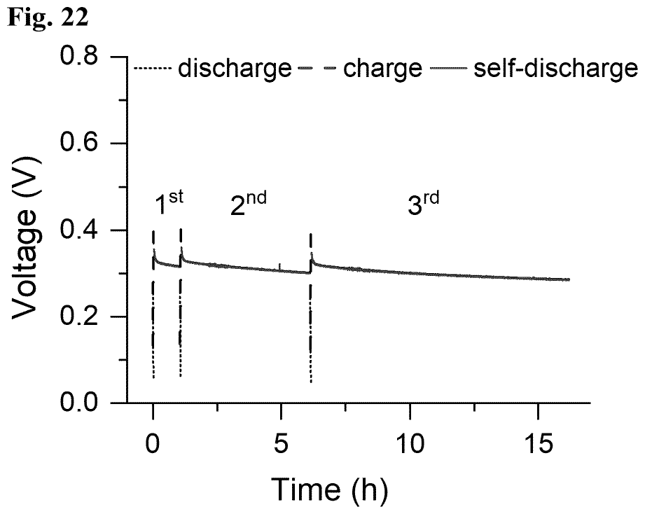

As a further test, the battery was charged by applying a current of 100 ∪A (166 ∪A cm⁻²) with cutoff voltages of 0 V and 1 V and reached a discharging capacity of 164.9 μAh cm⁻², as shown in FIG. 21a. FIG. 21b shows the electrical charging and discharging cycles of the battery, indicating that its capacity decreased because the mechanical stress, caused by the charging and discharging, detached PPy from the electrode. Nonetheless, the results confirm that the rechargeable battery of the present invention may also be used as a conventionally charged battery and be charged with an external electrical source.

### Self Discharging

The self-discharging of the battery was investigated by testing the OCV of the battery in the tear-like solution after being charged under a 100 μA current for 1 hour, 5 hours, and 10 hours, respectively, as shown in FIG. 22. From FIG. 22, there was negligible self-discharge after all three charge cycles, further highlighting the safety of this battery and that the battery was capable of preserving charge for long periods of time.

In the present battery, the enzymatic reaction of GOx and the self-reduction of PPy were used to easily charge the battery for further usage. Further, using enzymatic reactions on the anode, or using polymers with lower formal potential and possessing self-reduction behavior could further lower the potential of the anode and increase the voltage of the battery.

As a comparison, while conventional biofuel cells proposed for epidermal applications were able to supply an areal power (of about 3.6 mW cm⁻²), the same biofuel cells when integrated into contact lenses could not achieve the same maximum areal power because of the low biofuel concentration in the tear solution.

On the other hand, the rechargeable battery of the present invention can be easily charged with a biofuel solution, e.g., a glucose solution, and can supply higher power than the aforementioned biofuel cells proposed for smart contact lenses.

### Comparative Examples

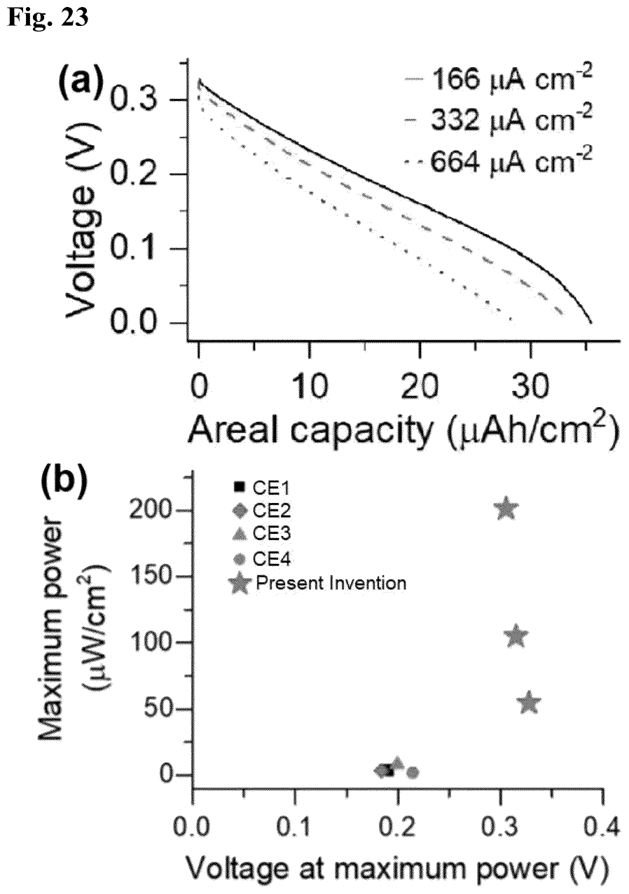

FIG. 23 compares the present rechargeable bio-charged battery with conventional biofuel cells on a contact lens, the exact values are further shown in Table 1. The rechargeable battery is compared with biofuel cells, without an external power supply as a proper comparison. The maximum areal powers of the battery were 54 W cm⁻², 105 W cm⁻², and 201 W cm⁻² at discharging currents of 166 μA cm⁻², 332 μA cm⁻², and 664 μA cm⁻², respectively after charging for 20 hours (FIG. 23a). At all three discharging current levels, the rechargeable battery far out-performed conventional biofuel cells (FIG. 23b), further highlighting the advantages of the rechargeable battery, especially when used in and to power smart contact lenses.

TABLE 1
Comparison of Present Invention Against Conventional Biofuel Cells

| | | | | | Discharging | Voltage at | Maximum |
|---|---|---|---|---|---|---|---|
| | | | | | Current | Maximum | Power |
| Examples | Biofuel Cell | Anode | Cathode | Electrolyte | (μA cm⁻²) | Power (V) | (μW cm⁻²) |
| Present Invention | | ppy | CuHCFe/GOx | Tears | 166 | 0.330 | 54 |
| | | | | | 332 | 0.325 | 105 |
| | | | | | 664 | 0.306 | 201 |
| CE1 | Glucose/O₂ | Au/CDH | Au/BOx | Tears | — | 0.2 | 3.5 |
| CE2 | Ascorbate/O₂ | Au/TTF-TCNQ | Au/BOx | Tears | 0.55 | 0.25 | 3.1 |
| CE3 | Lactate/O₂ | Buckypaper/Poly- | Buckypaper/ | Tears | 61.3 | 0.2 | 8.01 |
| | | MG/LDH + NAD⁺ | BOx | | | | |
| CE4 | Lactate/O₂ | NPG/LOx | NPG/BOx | Tears | 11.6 | 0.237 | 1.7 |

Key:
CDH: cellobiose dehydrogenase
BOx: bilirubin oxidase
TTF-TCNQ: tetrathiafulvalene-tetracyanoquinodimethane
Poly-MG: polymethylene green
LDH: L-lactate dehydrogenase
NAD+: β-nicotinamideadeninedinucleotidehydrate
NPG: nanoporous gold
LOx: lactate oxidase

### INDUSTRIAL APPLICABILITY

The present invention relates to a rechargeable battery for use in small wearable device applications, particularly smart contact lenses. The rechargeable battery of the present invention does not contain organic solvents, concentrated salts or heavy metals and thus do not pose a health risk to the user. The rechargeable battery also eliminates the need for membranes, transmitters, receivers or other components commonly required in conventional batteries, or biofuel cells and thus simplifies the difficulty and ease of miniaturization. The rechargeable battery may also easily be charged in a concentrated biofuel solution that poses no health risk to the user, while allowing the battery to be charged to full as compared to conventional biofuel cells that have to operate at much lower biofuel concentrations. Thus, this invention is capable of industrial applicability.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A rechargeable battery comprising:
(i) a cathode, the cathode comprising:
metal hexacyanometalate or hydrates thereof, or metal-doped metal hexacyanometalate or hydrates thereof, and
glucose oxidase; and
(ii) an anode comprising a self-reducing polymer.

2. The rechargeable battery of claim 1, wherein both the cathode and anode undergo self-charging.

3. The rechargeable battery of claim 1, wherein both the cathode and anode undergo self-charging in an electrolyte comprising glucose.

4. The rechargeable battery of claim 3, wherein the cathode self-charges via oxidation of the glucose by the glucose oxidase to produce H₂O₂ which oxidizes the metal hexacyanometalate or hydrates thereof, or the metal-doped metal hexacyanometalate or hydrates thereof.

5. The rechargeable battery of claim 3, wherein the electrolyte is selected from the group consisting of human tears, animal tears, and contact lens solution.

6. The rechargeable battery of claim 1, wherein the anode self-charges via self-reduction of the self-reducing polymer in the presence of hydroxide ions.

7. The rechargeable battery of claim 1, wherein the metal of the metal hexacyanometalate, or hydrates thereof, is selected from the group consisting of copper, manganese, iron, cobalt, nickel, and zinc;
wherein the hexacyanometalate of the metal hexacyanometalate, or hydrates thereof, or the hexacyanometalate of the metal-doped metal hexacyanometalate, or hydrates thereof, is selected from the group consisting of hexacyanoferrate, hexacyanidocobaltate, hexacyanochromate, hexacyanomanganate, and copper hexacyanoruthenate;
wherein the metal hexacyanometalate of the metal-doped metal hexacyanometalate, or hydrates thereof, is selected from the group consisting of copper hexacyanometalate, manganese hexacyanometalate, iron hexacyanometalate, cobalt hexacyanometalate, nickel hexacyanometalate, and zinc hexacyanometalate; or
wherein the metal-doped metal hexacyanometalate, or hydrates thereof, is selected from the group consisting of lithium-doped, sodium-doped, potassium-doped, rubidium-doped, caesium-doped, magnesium-doped, calcium-doped, zinc-doped, and aluminium-doped metal hexacyanometalate, or hydrates thereof.

8. The rechargeable battery of claim 1, wherein the cathode comprises a substrate, wherein the substrate is first coated with the metal hexacyanometalate, or hydrates thereof, or metal-doped metal hexacyanometalate, or hydrates thereof, and subsequently coated with the glucose oxidase.

9. The rechargeable battery of claim 1, wherein the substrate is selected from the group consisting of paper, porous paper, lens cleaning paper, current collector, film collector, carbon nanotube (CNT) film carbon film and glassy carbon.

10. The rechargeable battery of claim 1, wherein the self-reducing polymer is an optionally substituted polypyrrole.

11. The rechargeable battery of claim 10, wherein the optionally substituted polypyrrole is unsubstituted.

12. The rechargeable battery of claim 10, wherein the optionally substituted polypyrrole is substituted with at least one substituent selected from a group consisting of alkyl, alkenyl, alkynyl, thioalkyl, cycloalkyl, cycloalkenyl, heterocycloalkyl, halo, F, Cl, Br, I, carboxyl, haloalkyl, haloalkynyl, hydroxyl, alkoxy, thioalkoxy, alkenyloxy, haloalkoxy, haloalkenyloxy, nitro, amino, nitroalkyl, nitroalkenyl, nitroalkynyl, nitroheterocyclyl, alkylamino, dialkylamino, alkenylamine, alkynylamino, acyl, alkenoyl, alkynoyl, acylamino, diacylamino, acylamido, acyloxy, alkylsulfonyloxy, heterocycloxy, heterocycloamino, haloheterocycloalkyl, alkylsulfenyl, alkylcarbonyloxy, alkylthio, acylthio, phosphorus-containing groups such as phosphono and phosphinyl, aryl, heteroaryl, alkylaryl, alkylheteroaryl, cyano, cyanate, isocyanate,, carboxyl, carbonyl, —C(O)NH(alkyl), and —C(O)N(alkyl)₂.

13. The rechargeable battery of claim 1, wherein the cathode and anode each have a thickness that is less than the thickness of a contact lens.

14. The rechargeable battery of claim 1, wherein the cathode and anode each have a thickness that is less than 80 μm.

15. A contact lens comprising the rechargeable battery of claim 1.

16. The contact lens of claim 15, wherein the rechargeable battery is embedded within the contact lens.

17. The contact lens of claim 15, wherein the cathode and the anode of the rechargeable battery are embedded at the outer sides or edges of the contact lens.

18. The contact lens of claim 15, wherein the rechargeable battery undergoes charging while being worn by a user using the user's tears as an electrolyte.

19. The contact lens of claim 15, wherein the rechargeable battery undergoes charging while being worn by a user and without an external electrical power supply.

20. The contact lens of claim 15, wherein the contact lens comprises poly(hydroxyethyl methacrylate) (pHEMA), polymethylmethacrylate (PMMA), rigid gas permeable (RGP), silicone hydrogel, polyvinyl alcohol (PVA), or poly dimethyl siloxane (PDMS).
